(19) United States
(12) Patent Application Publication
(10) Pub. No.: US 2022/0270816 A1
(43) Pub. Date: Aug. 25, 2022

(54) TRANSFORMER AND SWITCHING POWER SUPPLY APPARATUS FOR REDUCING COMMON MODE NOISE DUE TO LINE-TO-GROUND CAPACITANCES

(71) Applicant: Panasonic Intellectual Property Management Co., Ltd., Osaka (JP)

(72) Inventors: Noriaki TAKEDA, Osaka (JP); Taiki NISHIMOTO, Osaka (JP); Naoki SAWADA, Osaka (JP)

(21) Appl. No.: 17/442,955

(22) PCT Filed: Feb. 12, 2020
(86) PCT No.: PCT/JP2020/005362

§ 371 Date: Mar. 23, 2022

(30) Foreign Application Priority Data
Mar. 26, 2019 (JP) 2019-058703

(51) Int. Cl. H01F 30/10; H02M 3/335; H01F 27/29; H01F 27/28

(52) U.S. Cl. CPC H01F 30/10; H02M 3/33573; H01F 27/29; H01F 27/2876; H01F 27/288; H01F 27/2828

(57) ABSTRACT

A core (X1) has a shape of a rectangular loop having sides (A1 to A4). The sides (A1, A3) are opposed to each other. The sides (A2, A4) are opposed to each other. A winding (w11) is wound around the core (X1) on the side (A2). A winding (w12) is wound around the core (X1) on the side (A4). A winding (w21) is wound around the core (X1) on the side (A2). A winding (w22) is wound around the core (X1) on the side (A4). The windings (w11, w12) are wound around the core (X1) at equal distances from the side (A1). The windings (w21, w22) are wound around the core (X1) at equal distances from the side (A1). The windings (w11, w12) are connected in series or in parallel to each other. The windings (w21, w22) are connected in series or in parallel to each other.

### CROSS-REFERENCE OF RELATED APPLICATIONS

This application is the U.S. National Phase under 35 U.S.C. § 371 of International Patent Application No. PCT/JP2020/005362, filed on Feb. 12, 2020, which in turn claims the benefit of Japanese Application No. 2019-058703, filed on Mar. 26, 2019, the entire disclosures of which Applications are incorporated by reference herein.

### TECHNICAL FIELD

The present disclosure relates to a transformer and a switching power supply apparatus.

### BACKGROUND ART

Conventionally, as a sort of switching power supply apparatus, DC-DC converters for converting a given DC voltage to a desired DC voltage are used. In particular, insulated DC-DC converters are used for industrial, on-board, or medical apparatuses required to be safe, such a converter including a transformer by which an input and an output of the DC-DC converter are insulated from each other, thus preventing electric leakage and electric shock.

Patent Document 1 discloses a switching power supply circuit provided with: a full-bridge switching circuit for converting DC voltage into AC voltage at a predetermined frequency by switching; and a transformer for converting the switched AC voltage to a predetermined voltage. Between the switching circuit and the transformer, a plurality of resonant circuits are provided, each including a capacitor and a coil connected in series, and connected to either end of a primary winding of the transformer. The switching power supply circuit of Patent Document 1 constitutes an LLC-resonant insulated DC-DC converter.

### CITATION LIST

### Patent Documents

PATENT DOCUMENT 1: Japanese Patent Laid-open Publication No. JP 2004-040923 A

### SUMMARY OF INVENTION

TECHNICAL PROBLEM

Patent Document 1 discloses that the plurality of series resonant circuits are connected to both ends of the primary winding of the transformer, respectively, so as to make voltage waveforms in the primary winding of the transformer symmetric, thus cancelling common mode voltages inputted to the primary winding of the transformer.

In other words, Patent Document 1 aims to reduce common mode noises, by establishing symmetry between characteristics of circuit elements connected to one end of the primary winding of the transformer, and characteristics of circuit elements connected to the other end thereof. However, even when configuring the circuit elements with symmetric characteristics, asymmetry of the circuit may occur due to parasitic capacitances (also referred to as “line-to-ground capacitances” in the present specification) between the transformer and other conductor portions (such as ground conductor and/or housing), and the like. A common mode noise may occur due to such asymmetry of the circuit. Hence, there is a need for a transformer less likely to generate a common mode noise due to line-to-ground capacitances.

An object of the present disclosure is to provide a transformer less likely to generate a common mode noise due to line-to-ground capacitances.

### Solution to Problem

According to an aspect of the present disclosure, a transformer is provided with: a core having a shape of a rectangular loop having first to fourth sides, the first and third sides being opposed to each other, and the second and fourth sides being opposed to each other; a first winding wound around the core on the second side of the core; a second winding wound around the core on the fourth side of the core; a third winding wound around the core on the second side of the core; and a fourth winding wound around the core on the fourth side of the core. The first and second windings are wound around the core at equal distances from the first side of the core. The third and fourth windings are wound around the core at equal distances from the first side of the core. The first and second windings are connected in series or in parallel to each other. The third and fourth windings are connected in series or in parallel to each other.

### Advantageous Effects of Invention

According to the aspect of the present disclosure, it is possible to provide a transformer less likely to generate a common mode noise due to line-to-ground capacitances.

### BRIEF DESCRIPTION OF DRAWINGS

FIG. 1 is a circuit diagram illustrating a configuration of a switching power supply apparatus provided with a transformer 311 according to a first embodiment.

FIG. 2 is a side view illustrating a configuration of the transformer 311 of FIG. 1.

FIG. 3 is a top view illustrating the configuration of the transformer 311 of FIG. 1.

FIG. 4 illustrates an arrangement of windings w11, w12, w21, and w22 of the transformer 311 of FIG. 1, in which (a) illustrates an arrangement of the windings w11 and w12 in a first layer, (b) illustrates an arrangement of the windings w11 and w12 in a second layer, (c) illustrates an arrangement of the windings w21 and w22 in a third layer, and (d) illustrates an arrangement of the windings w21 and w22 in a fourth layer.

FIG. 5 is a graph illustrating a frequency characteristic of a common mode noise generated in the switching power supply apparatus of FIG. 1.

FIG. 6 is a side view illustrating a configuration of a transformer 312 according to a first modified embodiment of the first embodiment.

FIG. 7 is a side view illustrating a configuration of a transformer 313 according to a second modified embodiment of the first embodiment.

FIG. 8 is a circuit diagram illustrating a configuration of a switching power supply apparatus provided with a transformer 321 according to the second embodiment.

FIG. 9 is a side view illustrating a configuration of the transformer 321 of FIG. 8.

FIG. 10 is a top view illustrating the configuration of the transformer 321 of FIG. 8.

FIG. 11 illustrates an arrangement of windings w11, w12, w21, and w22 of the transformer 321 of FIG. 8, in which (a) illustrates an arrangement of the windings w11 and w12 in a first layer, (b) illustrates an arrangement of the windings w11 and w12 in a second layer, (c) illustrates an arrangement of the windings w21 and w22 in a third layer, and (d) illustrates an arrangement of the windings w21 and w22 in a fourth layer.

FIG. 12 illustrates connections of windings w11, w12, w21, and w22 of the transformer 321 of FIG. 8.

FIG. 13 is a graph illustrating a frequency characteristic of a common mode noise generated in the switching power supply apparatus of FIG. 8.

FIG. 14 is a circuit diagram illustrating a configuration of a switching power supply apparatus provided with a transformer 331 according to a third embodiment.

FIG. 15 is a side view illustrating a configuration of the transformer 331 of FIG. 14.

FIG. 16 is a top view illustrating the configuration of the transformer 331 of FIG. 14.

FIG. 17 illustrates connections of windings w11, w12, w21, and w22 of the transformer 331 of FIG. 14.

FIG. 18 is a graph illustrating a frequency characteristic of a common mode noise generated in the switching power supply apparatus of FIG. 14.

FIG. 19 is a circuit diagram illustrating a configuration of a switching power supply apparatus provided with a transformer 341 according to a fourth embodiment.

FIG. 20 is a side view illustrating a configuration of the transformer 341 of FIG. 19. FIG. 21 is a top view illustrating the configuration of the transformer 341 of FIG. 19.

FIG. 22 illustrates connections of windings w11, w12, w21, and w22 of the transformer 341 of FIG. 19.

FIG. 23 is a graph illustrating a frequency characteristic of a common mode noise generated in the switching power supply apparatus of FIG. 19.

FIG. 24 is a side view illustrating a configuration of a transformer 351 according to a fifth embodiment.

FIG. 25 is a top view illustrating the configuration of the transformer 351 of FIG. 24.

FIG. 26 illustrates an arrangement of windings w11, w12, w21, and w22 of the transformer 351 of FIG. 24, in which (a) illustrates an arrangement of the windings w11 and w12 in a first layer, (b) illustrates an arrangement of the windings w11 and w12 in a second layer, (c) illustrates an arrangement of the windings w21 and w22 in a third layer, and (d) illustrates an arrangement of the windings w21 and w22 in a fourth layer.

FIG. 27 is a side view illustrating a configuration of a transformer 352 according to a first modified embodiment of the fifth embodiment.

FIG. 28 is a side view illustrating a configuration of a transformer 353 according to a second modified embodiment of the fifth embodiment.

FIG. 29 is a side view illustrating a configuration of a transformer 354 according to a third modified embodiment of the fifth embodiment.

FIG. 30 is a side view illustrating a configuration of a transformer 361 according to a sixth embodiment.

FIG. 31 is a top view illustrating the configuration of the transformer 361 of FIG. 30.

FIG. 32 illustrates an arrangement of windings w11, w12, w21, and w22 of the transformer 361 of FIG. 30, in which (a) illustrates an arrangement of the windings w11 and w12 in a first layer, (b) illustrates an arrangement of the windings w11 and w12 in a second layer, (c) illustrates an arrangement of the windings w21 and w22 in a third layer, and (d) illustrates an arrangement of the windings w21 and w22 in a fourth layer.

FIG. 33 illustrates connections of windings w11, w12, w21, and w22 of the transformer 361 of FIG. 30.

FIG. 34 is a side view illustrating a configuration of a transformer 371 according to a seventh embodiment.

FIG. 35 is a top view illustrating the configuration of the transformer 371 of FIG. 34.

FIG. 36 illustrates connections of windings w11, w12, w21, and w22 of the transformer 371 of FIG. 34.

FIG. 37 is a side view illustrating a configuration of a transformer 381 according to an eighth embodiment.

FIG. 38 is a top view illustrating the configuration of the transformer 381 of FIG. 37.

FIG. 39 illustrates connections of windings w11, w12, w21, and w22 of the transformer 381 of FIG. 37.

FIG. 40 is a block diagram illustrating a configuration of a switching power supply apparatus according to a ninth embodiment.

FIG. 41 is a block diagram illustrating a configuration of a switching power supply apparatus according to a modified embodiment of the ninth embodiment.

FIG. 42 is a circuit diagram illustrating a configuration of a switching power supply apparatus provided with a transformer 3 according to a comparison example.

FIG. 43 is a side view illustrating a configuration of the transformer 3 of FIG. 42.

FIG. 44 is a top view illustrating the configuration of the transformer 3 of FIG. 42.

FIG. 45 illustrates an arrangement of windings w1 and w2 of the transformer 3 of FIG. 42, in which (a) illustrates an arrangement of the winding w1 in a first layer, (b) illustrates an arrangement of the winding w1 in a second layer, (c) illustrates an arrangement of the winding w2 in a third layer, and (d) illustrates an arrangement of the winding w2 in a fourth layer.

FIG. 46 is an equivalent circuit diagram for explaining operations of the transformer 3 of FIG. 42.

### DESCRIPTION OF EMBODIMENTS

Hereinafter, embodiments of the present disclosure will be described with reference to the attached drawings. Note that in the following embodiments, similar constituents are denoted by the same reference signs.

First Embodiment

[Overall Configuration of First Embodiment]

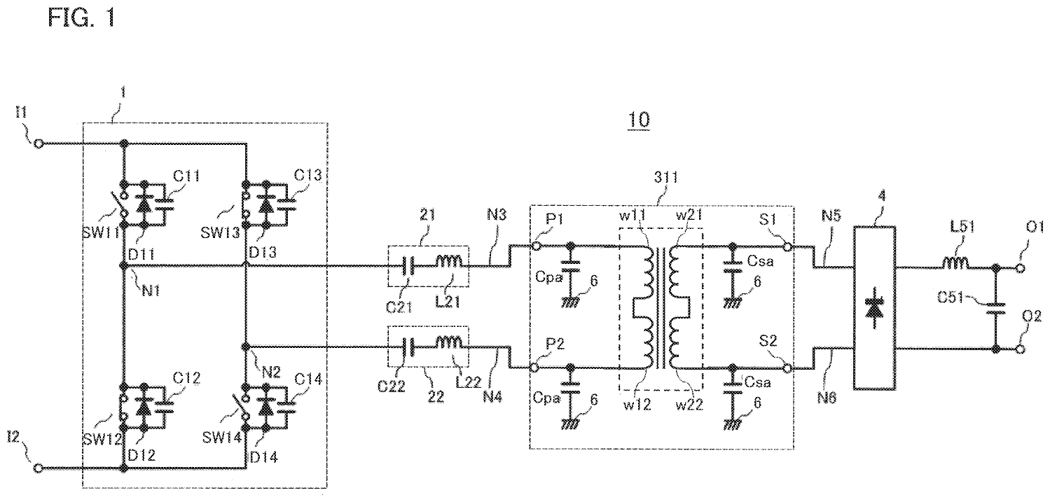

FIG. 1 is a circuit diagram illustrating a configuration of a switching power supply apparatus provided with a transformer 311 according to a first embodiment. The switching power supply apparatus of FIG. 1 includes an insulated DC-DC converter 10. The insulated DC-DC converter 10 is provided with: a full-bridge switching circuit 1, resonant circuits 21 and 22, a transformer 311, a rectifier circuit 4, a smoothing inductor L51, and a smoothing capacitor C51.

The switching circuit 1 is provided with: switching elements SW11 to SW14; and diodes D11 to D14 and capacitors C11 to C14, which are connected in parallel to the switching elements SW11 to SW14, respectively. The switching elements SW11 and SW12 are connected in series between input terminals I1 and I2 of the switching circuit 1. The switching elements SW13 and SW14 are connected in series between the input terminals I1 and I2 of the switching circuit 1, and connected in parallel to the switching elements SW11 and SW12. The switching elements SW11 to SW14 form a full-bridge switching circuit, with the switching elements SW11 and SW14 arranged diagonally, and with the switching elements SW12 and SW13 arranged diagonally. The switching circuit 1 converts DC voltage, which is inputted from the input terminals I1 and I2, into AC voltage at a predetermined frequency, and outputs the AC voltage to nodes N1 and N2, the node N1 being located between the switching elements SW11 and SW12, and to the node N2 being located between the switching elements SW13 and SW14.

For example, in a case where the switching elements are MOSFETs, the diodes D11 to D14 and the capacitors C11 to C14 may be configured by parasitic diodes (body diodes) and junction capacitances (drain-source capacitances) of the switching elements SW11 to SW14, respectively.

The transformer 311 has terminals P1 and P2 connected to a primary winding, and has terminals S1 and S2 connected to a secondary winding. The AC voltage generated by the switching circuit 1 is applied to the primary winding of the transformer 311 through the terminals P1 and P2. In addition, AC voltage, which is boosted or stepped down depending on a turns ratio, is generated at the secondary winding of the transformer 311, and the generated AC voltage is outputted through the terminals S1 and S2. A detailed configuration of the transformer 311 will be described later.

In the present specification, a conductor portion including a wiring conductor and the like connected to the terminal P1 of the transformer 311 is also referred to as a “node N3”, and a conductor portion including a wiring conductor and the like connected to the terminal P2 of the transformer 311 is also referred to as a “node N4”. In addition, in the present specification, a conductor portion including a wiring conductor and the like connected to the terminal S1 of the transformer 311 is also referred to as a “node N5”, and a conductor portion including a wiring conductor and the like connected to the terminal S2 of the transformer 311 is also referred to as a “node N6”.

According to the example of FIG. 1, the terminal P1 of the transformer 311 is connected via the resonant circuit 21 to the node N1 of the switching circuit 1, and the terminal P2 of the transformer 311 is connected via the resonant circuit 22 to the node N2 of the switching circuit 1. The resonant circuit 21 is a series resonant circuit including a first resonant capacitor C21 and a first resonant inductor L21 connected in series. The resonant circuit 22 is a series resonant circuit having a second resonant capacitor C22 and a second resonant inductor L22 connected in series. The resonant circuits 21 and 22, and inductance of the primary winding of the transformer 311 form an LLC resonant circuit. As a result of resonance of the resonant circuits 21 and 22 and the inductance of the primary winding of the transformer 311, a current having a sinusoidal waveform flows.

The rectifier circuit 4 is connected to the terminals S1 and S2 of the transformer 311, and rectifies the AC voltage outputted from the terminals S1 and S2. The rectifier circuit 4 is, for example, a diode bridge circuit.

The smoothing inductor L51 and the smoothing capacitor C51 form a smoothing circuit, which smooths the voltage rectified by the rectifier circuit 4, and generates a desired DC voltage between output terminals O1 and O2.

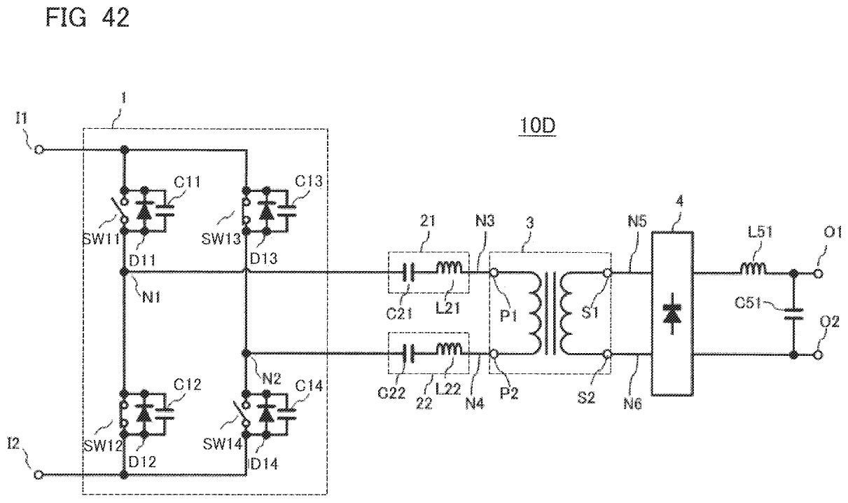

The insulated DC-DC converter 10 is further provided with a conductor portion 6. The conductor portion 6 is, for example, a ground conductor (for example, a GND wiring of a circuit board), or a shield, a metal housing, or a heat sink. When the conductor portion 6 is provided separately from the ground conductor of the circuit (that is, when the conductor portion 6 is a metal housing, a shield, or a heat sink), a voltage potential of the conductor portion 6 may be the same as, or different from that of the ground conductor of the circuit. The transformer 311 is arranged on the conductor portion 6. As described later, the insulated DC-DC converter 10 has parasitic capacitances between the primary winding of the transformer 311 and the conductor portion 6, and between the secondary winding of the transformer 311 and the conductor portion 6. In the present specification, such parasitic capacitances are also referred to as “line-to-ground capacitances”.

[Configuration of Comparison Example]Now, a switching power supply apparatus provided with a transformer according to a comparison example will be explained with reference to FIGS. 42 to 46.

FIG. 42 is a circuit diagram illustrating a configuration of a switching power supply apparatus provided with a transformer 3 according to a comparison example. The switching power supply apparatus of FIG. 42 includes an insulated DC-DC converter 10D. The insulated DC-DC converter 10D is provided with: a full-bridge switching circuit 1, resonant circuits 21 and 22, a transformer 3, a rectifier circuit 4, a smoothing inductor L51, and a smoothing capacitor C51. The insulated DC-DC converter 10D is provided with the transformer 3, in place of the transformer 311 of FIG. 1. The other components of the insulated DC-DC converter 10D, other than the transformer 3, are configured in a manner similar to that of the corresponding components of FIG. 1.

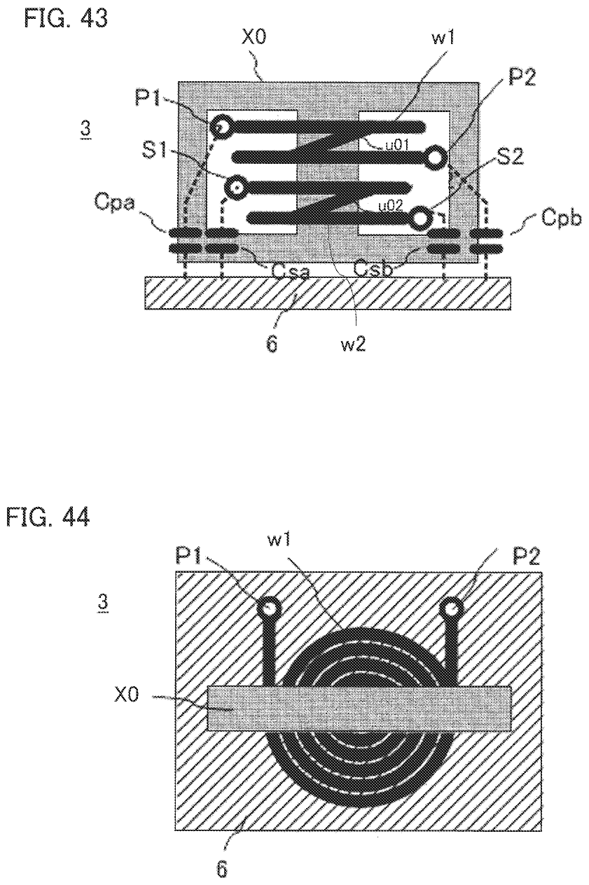

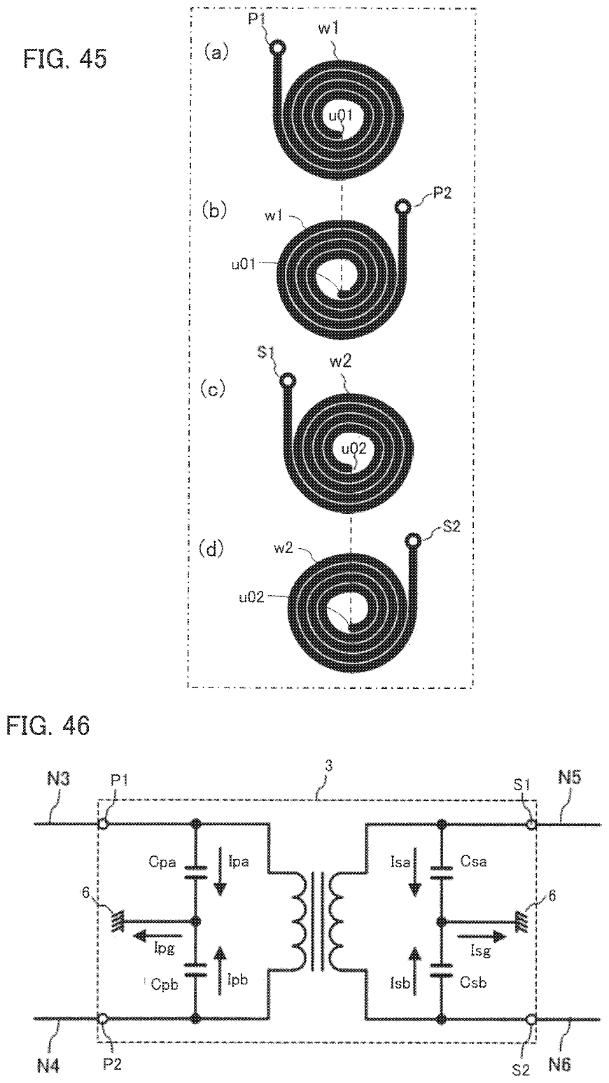

FIG. 43 is a side view illustrating a configuration of the transformer 3 of FIG. 42. FIG. 44 is a top view illustrating the configuration of the transformer 3 of FIG. 42. FIG. 45 illustrates an arrangement of windings w1 and w2 of the transformer 3 of FIG. 42. As illustrated in FIGS. 43 to 45, the transformer 3 is provided with a core X0, a primary winding w1, and a secondary winding w2, and disposed on a conductor portion 6.

According to the examples of FIGS. 43 to 45, the transformer 3 has a four-layered structure, including the primary winding w1 wound in two layers, and the secondary winding w2 wound in two layers. In the present specification, the uppermost layer in FIG. 43 (the layer of the winding, farthest from the conductor portion 6) is referred to as a first layer, and the lowermost layer in FIG. 43 (the layer of the winding, closest to the conductor portion 6) is referred to as a fourth layer. FIG. 45(a) illustrates an arrangement of the winding w1 in the first layer, FIG. 45(b) illustrates an arrangement of the winding w1 in the second layer, FIG. 45(c) illustrates an arrangement of the winding w2 in the third layer, and FIG. 45(d) illustrates an arrangement of the winding w2 in the fourth layer. In the first layer, the primary winding w1 is wound inwards from the terminal P1, and then, connected to the second layer via a connection u01 near a central portion of the core X0 (a portion extending vertically in FIG. 43), and in the second layer, the primary winding w1 is wound outwards from near the central portion of the core X0, and then, connected to the terminal P2. Similarly, in the third layer, the secondary winding w2 is wound inwards from the terminal S1, and then, connected to the fourth layer via a connect u02 near the central portion of the core X0, and in the fourth layer, the secondary winding w2 is wound outwards from near the central portion of the core X0, and then, connected to the terminal S2.

The insulated DC-DC converter 10D has line-to-ground capacitance Cpa between the terminal P1 of the primary winding of the transformer 3 and the conductor portion 6, and has line-to-ground capacitance Cpb between the terminal P2 of the primary winding of the transformer 3 and the conductor portion 6. In addition, the insulated DC-DC converter 10D has line-to-ground capacitance Csa between the terminal S1 of the secondary winding of the transformer 3 and the conductor portion 6, and has line-to-ground capacitance Csb between the terminal S2 of the secondary winding of the transformer 3 and the conductor portion 6. The line-to-ground capacitances Cpa, Cpb, Csa, and Csb are parasitic capacitances that exist between the terminals P1, P2, S1, and S2 of the transformer 3 and the conductor portion 6, respectively.

The insulated DC-DC converter 10D has substantially the same configuration as that of the switching power supply circuit of Patent Document 1.

Here, an average of voltage potentials at the terminals P1 and P2 of the primary winding of the transformer 3 is also referred to as a “common mode voltage”. A current is generated by the common mode voltage applied to the line-to-ground capacitances Cpa, Cpb, Csa, and Csb of the transformer 3, and this current propagates to the conductor portion 6 and outward from the circuit, as a common mode noise.

According to the configuration of FIG. 42, the resonant circuits 21 and 22 are symmetrically connected between the nodes N1, N2 of the switching circuit 1 and the terminals P1, P2 of the primary windings of the transformer 3, and therefore, it is possible to make waveforms of the voltage potentials at the nodes N3, N4 symmetrical about a ground potential. Thus, it is possible to reduce variation in the average of the voltage potentials at the terminals P1 and P2 of the primary winding of the transformer 3. In particular, the variation in the average of the voltage potentials at the terminals P1 and P2 of the primary winding of the transformer 3 is minimized, by setting, to the resonant circuits 21 and 22, identical circuit constants determining resonance frequencies of the resonant circuits 21 and 22 (that is, capacitances of the resonant capacitors C21, C22, and inductances of the resonant inductors L21, L22). Furthermore, when the variation in the average of the voltage potentials at the terminals P1 and P2 of the primary windings of the transformer 3 is minimized, it is expected that the common mode noise propagating outwards from the circuit via the line-to-ground capacitances Cpa, Cpb, Csa, and Csb and the conductor portion 6 is minimized. Therefore, it is expected that the common mode noise is reduced by symmetrically configuring the circuit of the switching power supply apparatus as described above.

However in practice, the aforementioned symmetrical circuit configuration of the switching power supply apparatus may be insufficient as countermeasure against the common mode noise. This is because the line-to-ground capacitances Cpa and Cpb at the terminals P1 and P2 of the primary winding of the transformer 3 are not exactly the same, and because the line-to-ground capacitances Csa and Csb at the terminals S1 and S2 of the secondary winding of the transformer 3 are not exactly the same (that is, they are asymmetric). When the transformer 3 is configured as illustrated in FIGS. 43 to 45, since distances from the conductor portion 6 to the terminals P1 and P2 of the primary winding w1 are different from each other, the line-to-ground capacitances Cpa and Cpb are different from each other, and thus asymmetric. Referring to the example of FIG. 43, the distance from the conductor portion 6 to the terminal P1 is longer than the distance from the conductor portion 6 to the terminal P2, resulting in Cpa<Cpb. Similarly, since distances from the conductor portion 6 to the terminals S1 and S2 of the secondary winding w2 are different from each other, the line-to-ground capacitances Csa and Csb are different from each other, and thus asymmetric. Referring to the example of FIG. 43, the distance from the conductor portion 6 to the terminal S1 is longer than the distance from the conductor portion 6 to the terminal S2, resulting in Csa<Csb. As described above, even the resonant circuits 21 and 22 are symmetrically connected between the nodes N1, N2 of the switching circuit 1 and the terminals P1, P2 of the primary windings of the transformer 3, the common mode noise may occur due to asymmetry of the line-to-ground capacitances Cpa, Cpb, Csa, and Csb.

FIG. 46 is an equivalent circuit diagram for explaining operations of the transformer 3 of FIG. 42. FIG. 46 is focused on the transformer 3, the nodes N3 and N4 connected to the primary side thereof, and the nodes N5 and N6 connected to the secondary side thereof as illustrated in FIG. 42. A mechanism of generating the common mode noise will be explained referring to FIG. 46.

The common mode noise generated on the primary side of the transformer 3 in the insulated DC-DC converter 10D is expressed as follows.

Let V3 be a voltage potential at the node N3, and let V4 be a voltage potential at the node N4. When the resonant circuits 21 and 22 are symmetrically connected between the nodes N1, N2 of the switching circuit 1 and the terminals P1, P2 of the primary windings of the transformer 3, the voltage potentials V3, V4 can be made symmetrical about the ground potential.

V3=−V4 (Equation 1)

Since the conductor portion 6 can be regarded as being grounded, the voltage potentials V3, V4 are expressed as follows.

V3=Ipa/(j×ω×Cpa) (Equation 2)

V4=Ipb/(j×(A)×Cpb) (Equation 3)

Where Ipa denotes a current flowing from the node N3 via the line-to-ground capacitance Cpa of the transformer 3, and Ipb denotes a current flowing from the node N4 via the line-to-ground capacitance Cpb of the transformer 3.

In addition, let Ipg be the current flowing from the line-to-ground capacitances Cpa, Cpb into the conductor portion 6, the following equation is obtained using the Kirchhoff s law.

Ipg=Ipa+Ipb (Equation 4)

By substituting Equation 2 and Equation 3 into Equation 4, the following equation is obtained.

Ipg=j×ω×CpaxV3+j×ω×Cpb×V4 (Equation 5)

Let V3=Vp, then Equation 5 is expressed as follows using Equation 1.

Ipg=j ×ω×Cpa×Vp−j×ω×Cpb×Vp (Equation 6)

In this case, since Cpa<Cpb, the current Ipg≠0 flows into the conductor portion 6 via the line-to-ground capacitances Cpa and Cpb. The current Ipg becomes the common mode noise, and propagates outwards from the circuit via the conductor portion 6.

Therefore, according to Formula 6, a condition for reducing the common mode noise generated on the primary side of the transformer 3 in the insulated DC-DC converter 10D, that is, a condition for Ipg=0, is given as follows.

Cpa=Cpb (Equation 7)

or

“Line-to-ground capacitance seen from node N3”=“Line-to-ground capacitance seen from node N4” (Equation 8)

The common mode noise generated on the secondary side of the transformer 3 in the insulated DC-DC converter 10D is expressed as follows.

Let V5 be the voltage potential of the node N5, and let V6 be the voltage potential of the node N6. When the rectifier circuit 4 including the symmetrical diode bridge circuit is connected to the terminals S1 and S2 of the secondary winding of the transformer 3, the voltage potentials V5 and V6 can be made symmetrical about the ground potential.

V5=−V6 (Equation 9)

Let V5=Vs, then a current Isg flowing from the line-to-ground capacitances Csa and Csb into the conductor portion 6 is expressed as follows, in a manner similar to that of the primary side of the transformer 3.

Isg=j×ω×Csa×Vs−j×ω×Csb×Vs (Equation 10)

In this case, since Csa<Csb, the current Isg*0 flows into the conductor portion 6 via the line-to-ground capacitances Csa and Csb. The current Isg becomes the common mode noise, and propagates outwards from the circuit. via the conductor portion 6

Therefore, according to Equation 10, a condition for reducing the common mode noise generated on the secondary side of the transformer 3 in the insulated DC-DC converter 10D, that is, a condition for Isg=0, is given as follows.

Csa=Csb (Equation 11)

or

“Line-to-ground capacitance seen from node N5”=“Line-to-ground capacitance seen from node N6” (Equation 12)

Embodiments of the present disclosure provide a transformer and a switching power supply apparatus less likely to generate the common mode noise due to the line-to-ground capacitances, through configuration for cancelling asymmetry of the line-to-ground capacitances at both ends of the primary winding, and cancelling asymmetry of the line-to-ground capacitances at both ends of the secondary winding.

[Features of First Embodiment]

A transformer according to each embodiment of the present disclosure is characterized by: a primary winding wound around a core so as to cancel asymmetry of line-to-ground capacitances at both ends; and a secondary winding wound around the core so as to cancel asymmetry of line-to-ground capacitances at both ends.

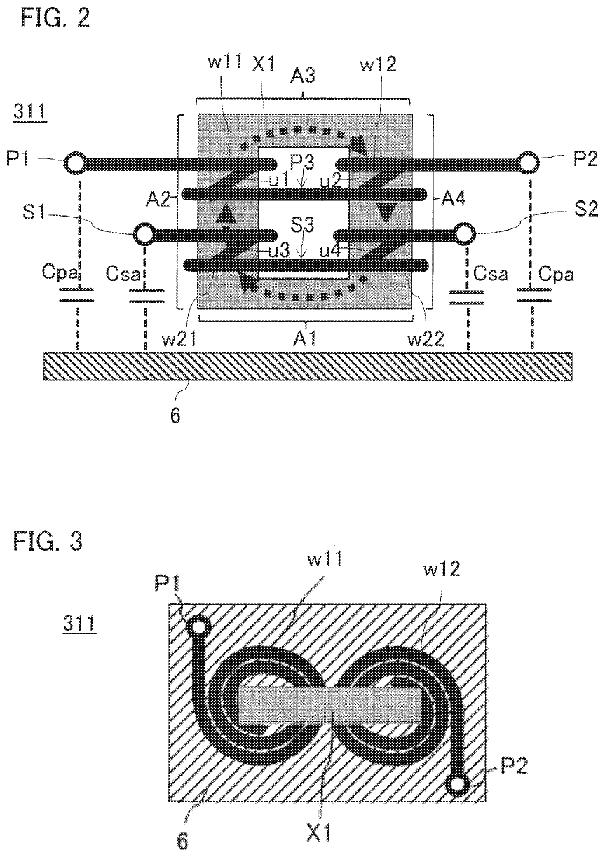

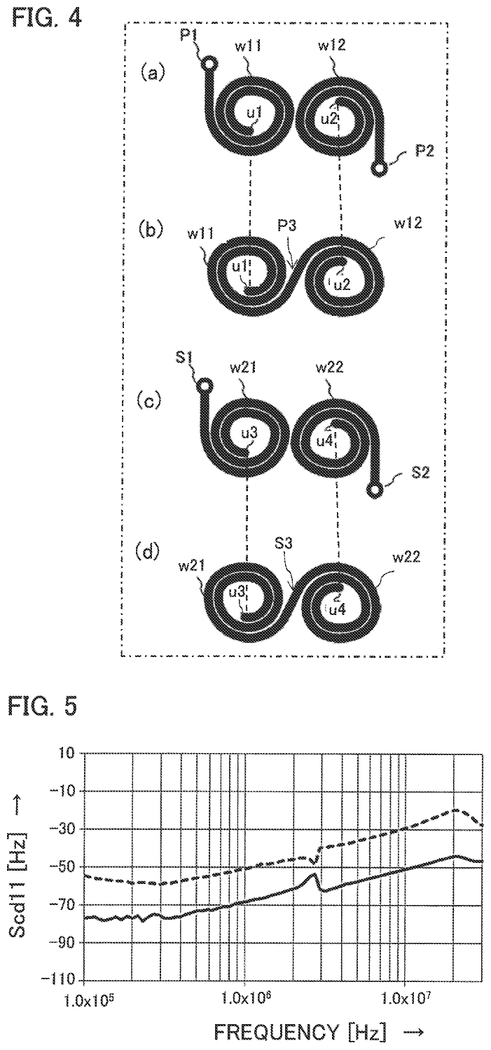

FIG. 2 is a side view illustrating a configuration of the transformer 311 of FIG. 1. FIG. 3 is a top view illustrating the configuration of the transformer 311 of FIG. 1. FIG. 4 illustrates an arrangement of windings w11, w12, w21, and w22 of the transformer 311 of FIG. 1. As illustrated in FIGS. 2 to 4, the transformer 311 is provided with a core X1, primary windings w11 and w12, and secondary windings w21 and w22, and disposed on the conductor portion 6.

In the present specification, the winding w11 is also referred to as a “first winding”, the winding w12 is also referred to as a “second winding”, the winding w21 is also referred to as a “third winding”, and the winding w22 is also referred to as a “fourth winding”.

The core X1 has a shape of a rectangular loop having a first side A1 to a fourth side A4 (that is, a loop made of four core portions extending along four sides of the rectangle, respectively). The core X1 is configured such that the first side A1 and the third side A3 are opposed to each other, and the second side A2 and the fourth side A4 are opposed to each other. The side A1 and the side A3 of the core X1 are provided in parallel to the conductor portion 6.

The winding w11 is wound around the core X1 on the side A2 of the core X1. The winding w12 is wound around the core X1 on the side A4 of the core X1. The winding w21 is wound around the core X1 on the side A2 of the core X1. The winding w22 is wound around the core X1 on the side A4 of the core X1. The winding w11 has a first terminal P1 and a second terminal P3. The winding w12 has a third terminal P2 and a fourth terminal P3. The windings w11 and w12 are connected to each other at the terminal P3. The winding w21 has a fifth terminal S1 and a sixth terminal S3. The winding w22 has a seventh terminal S2 and an eighth terminal S3. The windings w21 and w22 are connected to each other at the terminal S3.

According to the first embodiment, the windings w11 and w12 may form a single winding, and in this case, a midpoint of the winding is assumed to be the terminal P3. In addition, according to the first embodiment, the windings w21 and w22 may form a single winding, and in this case, a midpoint of the winding is assumed to be the terminal S3.

According to the first embodiment, the windings w11 and w12 are connected in series to each other on the primary side of the transformer 311, and the windings w21 and w22 are connected in series to each other on the secondary side of the transformer 311.

The windings w11 and w12 are wound around the core X1 so that when a current flows between the terminals P1 and P2, the windings w11 and w12 generate magnetic fluxes in an identical direction along the loop of the core X1. For example, the windings w11 and w12 are wound around the core X1 so that when a current flows from the terminal P1 towards the terminal P2, the winding w11 generates magnetic flux in a clockwise direction along the loop of the core X1 (see FIG. 2), and the winding w12 generates magnetic flux in the clockwise direction along the loop of the core X1. The windings w21 and w22 are wound around the core X1 so that when a current flows between the terminals S1 and S2, the windings w21 and w22 generate magnetic fluxes in an identical direction along the loop of the core X1. For example, the windings w21 and w22 are wound around the core X1 so that when a current flow from the terminal S1 toward the terminal S2, the winding w21 generates magnetic flux in the clockwise direction along the loop of the core X1 (see FIG. 2), and the winding w22 generates magnetic flux in the clockwise direction along the loop of the core X1.

The windings w11 and w12 are wound around the core X1 at equal distances from the side A1 of the core X1 (that is, from the conductor portion 6). The terminals P1 and P2 are provided at equal distances from the side A1 of the core X1. The windings w21 and w22 are wound around the core X1 at equal distances from the side A1 of the core X1. The terminals S1 and S2 are provided at equal distances from the side A1 of the core X1. In this case, the distance from the side A1 of the core X1 to each of the windings w11, w12, w21, and w22 may be defined, for example, as the shortest distance from the side A1 of the core X1 to each of the windings w11, w12, w21, and w22.

Referring to the example of FIGS. 2 to 4, the transformer 311 has a four-layered structure, including the windings w11 and w12 wound in two layers, respectively, and the windings w21 and w22 wound in two layers, respectively. In the present specification, the uppermost layer in FIG. 2 (the layer of the winding, farthest from the conductor portion 6) is referred to as a first layer, and the lowermost layer in FIG. 2 (the layer of the winding, closest to the conductor portion 6) is referred to as a fourth layer. FIG. 4(a) illustrates an arrangement of the windings w11 and w12 in the first layer, FIG. 4(b) illustrates an arrangement of the windings w11 and w12 in the second layer, FIG. 4(c) illustrates an arrangement of the windings w21 and w22 in the third layer, and FIG. 4(d) illustrates an arrangement of the windings w21 and w22 in the fourth layer. In the first layer, the winding w11 is wound inwards from the terminal P1, and then, connected to the second layer via a connection u1 near the side A2 of the core X1, and in the second layer, the winding w11 is wound outwards from near the side A2 of the core X1, and then, connected to the terminal P3. In the first layer, the winding w12 is wound inwards from the terminal P2, and then, connected to the second layer via a connection u2 near the side A4 of the core X1, and in the second layer, the winding w11 is wound outwards from near the side A4 of the core X1, and then, connected to the terminal P3. In the third layer, the winding w21 is wound inwards from the terminal Si, and then, connected to the fourth layer via a connection u3 near the side A2 of the core X1, and in the fourth layer, the winding w11 is wound outwards from near the side A2 of the core X1, and then, connected to the terminal S3. In the third layer, The winding w22 is wound inwards from the terminal S2, and then, connected to the fourth layer via a connection u4 near the side A4 of the core X1, and in the fourth layer, the winding w11 is wound outwards from near the side A4 of the core X1, and then, connected to the terminal S3.

The insulated DC-DC converter 10 has line-to-ground capacitance Cpa between the terminal P1 and the conductor portion 6, and has line-to-ground capacitance Cpa between the terminal P2 and the conductor portion 6. Since the terminals P1 and P2 of the primary windings of the transformer 311 are provided at equal distances from the conductor portion 6, these line-to-ground capacitances are equal to each other. In addition, the insulated DC-DC converter 10 has the line-to-ground capacitance Csa between the terminal S1 and the conductor portion 6, and has the line-to-ground capacitance Csa between the terminal S2 and the conductor portion 6. Since the terminals S1 and S2 of the secondary windings of the transformer 311 are provided at equal distances from the conductor portion 6, these line-to-ground capacitances are equal to each other.

Since the insulated DC-DC converter 10 of FIG. 1 is provided with the transformer 311 configured as described above, the following conditions are satisfied on the primary side of the transformer 311:

“line-to-ground capacitance seen from node N3”=Cpa, and “line-to-ground capacitance seen from node N4”=Cpa.

Since the line-to-ground capacitance seen from the node N3 and the line-to-ground capacitance seen from the node N4 can be made equal to each other, the condition of Equation 8 is satisfied, and thus Ipg=0, and therefore, it is possible to reduce the common mode noise generated on the primary side of the transformer 311.

Similarly, since the insulated DC-DC converter 10 of FIG. 1 is provided with the transformer 311 as described above, the following conditions are satisfied on the secondary side of the transformer 311:

“line-to-ground capacitance seen from node N5”=Csa, and “line-to-ground capacitance seen from node N6”=Csa. Since the line-to-ground capacitance seen from the node N5 and the line-to-ground capacitance seen from the node N6 can be made equal to each other, the condition of Equation 12 is satisfied, and thus Isg=0, and therefore, it is possible to reduce the common mode noise generated on the secondary side of the transformer 311.

FIG. 5 is a graph illustrating a frequency characteristic of a common mode noise generated in the switching power supply apparatus of FIG. 1. Referring to FIG. 5, a solid line indicates a simulation result of the switching power supply apparatus of FIG. 1 (first embodiment), and a broken line indicates a simulation result of the switching power supply apparatus of FIG. 42 (comparison example). With reference to the analytical result of FIG. 5, we will explain an effect of reducing the common mode noise using the switching power supply apparatus of the first embodiment. A normal mode noise is generated at the nodes N1 and N2 by operating the switching elements SW11 to SW14 of the switching circuit 1, and the normal mode noise is converted into a common mode noise, and then, the common mode noise propagates to the conductor portion 6. With respect to four-port S-parameters for the nodes N1, N2, N5, and N6, an amount of the normal mode noise converted to the common mode noise and then propagating to the conductor portion 6, that is, a mixed mode S-parameter Scd 11, was calculated. The capacitance of the resonant capacitors was set to C21=C22=20 nF, and the inductance of the resonant inductor was set to L21=L22=0 H (short-circuited). As can be seen from FIG. 5, the common mode noise of the switching power supply apparatus of FIG. 1 (solid line) is reduced than that of the switching power supply apparatus of FIG. 42 (broken line).

As described above, according to the switching power supply apparatus of the first embodiment, it is possible to cancel the asymmetry of the line-to-ground capacitances at both ends of the primary winding, by providing the windings w11 and w12 wound on the primary side of the transformer 311 as illustrated in FIGS. 2 to 4.

In addition, it is possible to cancel the asymmetry of the line-to-ground capacitances at both ends of the secondary winding, by providing the windings w21 and w22 wound on the secondary side of the transformer 311 as illustrated in FIGS. 2 to 4. Thus, the common node noise due to the line-to-ground capacitances of the transformer 311 can be made less likely to occur.

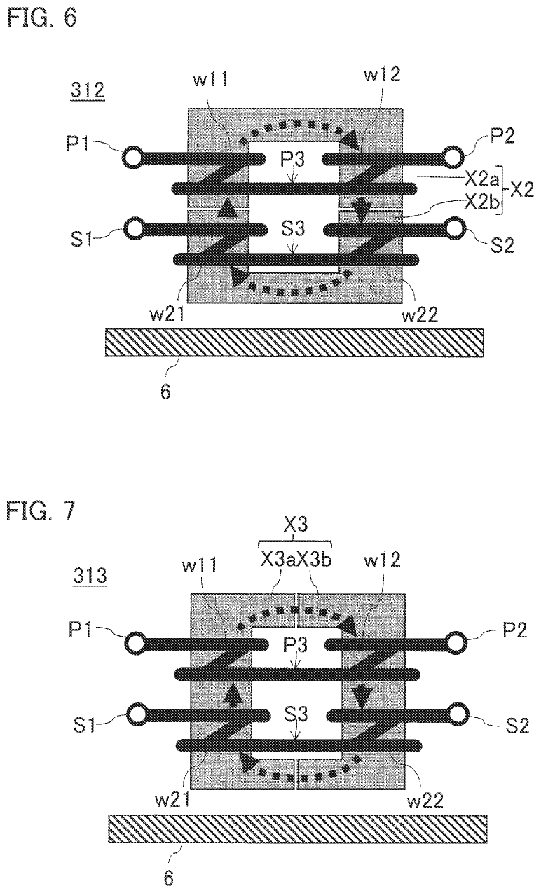

FIG. 6 is a side view illustrating a configuration of a transformer 312 according to a first modified embodiment of the first embodiment. The transformer 312 of FIG. 6 is provided with a core X2 made of two core portions X2a and X2b, in place of the core X1 of FIG. 2. By providing gaps between the core portions X2a and X2b, magnetic saturation in the core X2 can be made less likely to occur. The core X2 may have only one gap, or two or more gaps, along the loop thereof. In addition, by using the core X2 split into two core portions X2a and X2b, it is possible to more easily wind the windings around the core, as compared with the case of using a loop-shaped integrated core, thus facilitating manufacturing of the transformer. In addition, by inserting radiators between the core portions X2a and X2b, it is possible to improve cooling performance of the transformer 312.

FIG. 7 is a side view illustrating a configuration of a transformer 313 according to a second modified embodiment of the first embodiment. The transformer 313 of FIG. 7 is provided with a core X3 made of two core portions X3a and X3b, in place of the core X1 of FIG. 2. By providing gaps between the core portions X3a and X3b, magnetic saturation in the core X3 can be made less likely to occur. The core X3 may have only one gap, or two or more gaps, along the loop thereof. In addition, by using the core X3 split into two core portions X3a and X3b, it is possible to more easily wind the windings around the core, as compared with the case of using a loop-shaped integrated core, thus facilitating manufacturing of the transformer. In addition, by inserting radiators between the core portions X3a and X3b, it is possible to improve cooling performance of the transformer 313.

Second Embodiment

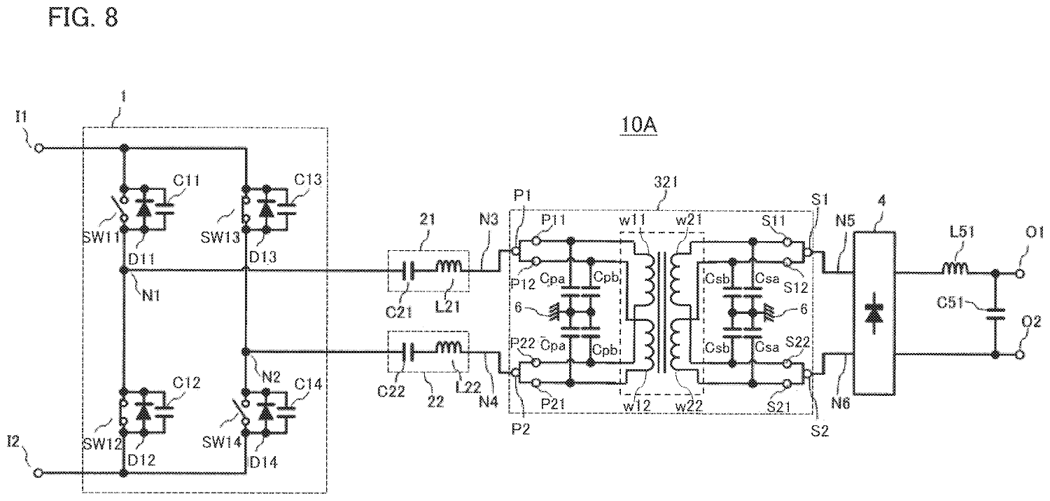

FIG. 8 is a circuit diagram illustrating a configuration of a switching power supply apparatus provided with a transformer 321 according to the second embodiment. The switching power supply apparatus of FIG. 8 includes an insulated DC-DC converter 10A. The insulated DC-DC converter 10A is provided with: a full-bridge switching circuit 1, resonant circuits 21 and 22, the transformer 321, a rectifier circuit 4, a smoothing inductor L51, and a smoothing capacitor C51. The insulated DC-DC converter 10A is provided with the transformer 321, in place of the transformer 311 of FIG. 1. The other components of the insulated DC-DC converter 10A, other than the transformer 321, are configured in a manner similar to that of the corresponding components of FIG. 1.

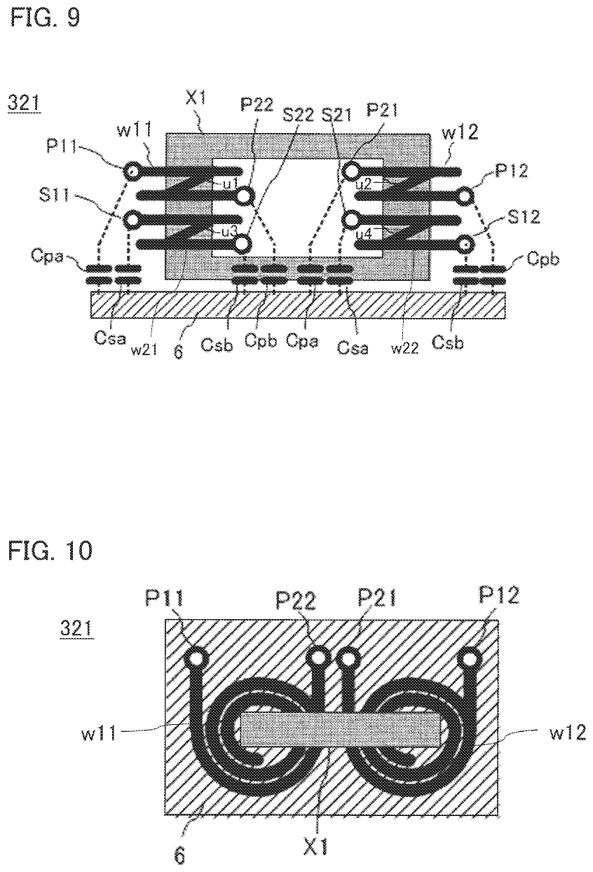

FIG. 9 is a side view illustrating a configuration of the transformer 321 of FIG. 8. FIG. 10 is a top view illustrating the configuration of the transformer 321 of FIG. 8.

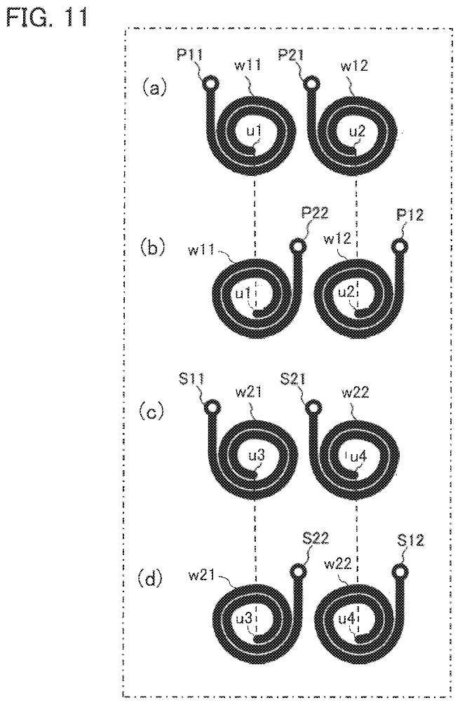

FIG. 11 illustrates an arrangement of windings w11, w12, w21, and w22 of the transformer 321 of FIG. 8. FIG. 11(a) illustrates an arrangement of the windings w11 and w12 in the first layer, FIG. 11(b) illustrates an arrangement of the windings w11 and w12 in the second layer, FIG. 11(c) illustrates an arrangement of the windings w21 and w22 in the third layer, and FIG. 11(d) illustrates an arrangement of the windings w21 and w22 in the fourth layer.

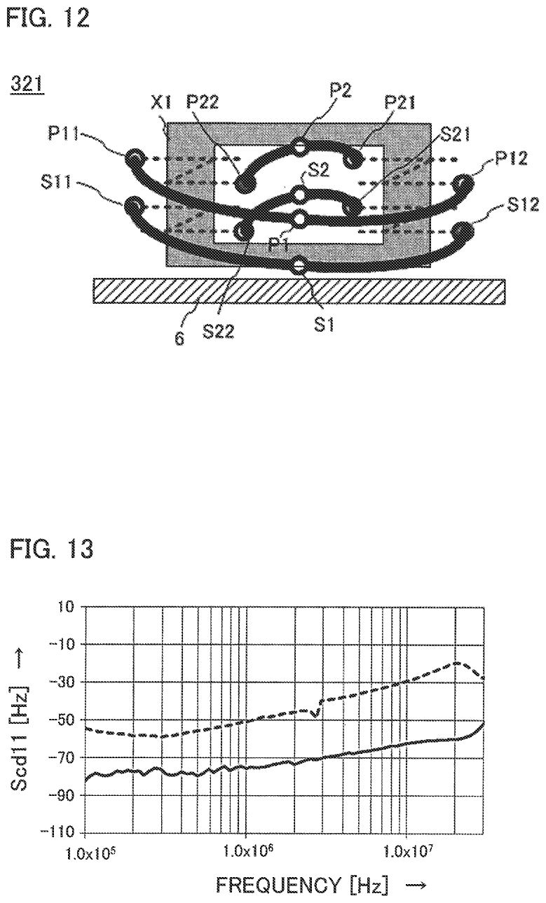

FIG. 12 illustrates connections of the windings w11, w12, w21, and w22 of the transformer 321 of FIG. 8. As illustrated in FIGS. 9 to 12, the transformer 321 is provided with a core X1, primary windings w11 and w12, and secondary windings w21 and w22, and disposed on a conductor portion 6.

The core X1 of FIGS. 9 to 12 is configured in a manner similar to those of the core X1 of FIGS. 2 to 4, the core X2 of FIG. 6, or the core X3 of FIG. 7.

Each of the windings w11, w12, w21, and w22 of FIGS. 9 to 12 is wound at a similar position as that of the corresponding winding w11, w12, w21, or w22 of FIGS. 2 to 4, on the corresponding side of the core X1. The winding w11 has a first terminal P11 and a second terminal P22. The winding w12 has a third terminal P21 and a fourth terminal P12. The winding w21 has a fifth terminal S11 and a sixth terminal S22. The winding w22 has a seventh terminal S21 and an eighth terminal S12.

Referring to FIG. 12, the windings w11 and w12 are connected to each other at the terminals P11 and P12, and connected to each other at the terminals P22 and

P21. The terminals P11 and P12 are connected to the terminal P1 on the primary side of the transformer 321, and the terminals P21 and P22 are connected to the terminal P2 on the primary side of the transformer 321. In addition, the windings w21 and w22 are connected to each other at the terminals S11 and S12, and connected to each other at the terminals S22 and S21. The terminals S11 and S12 are connected to the terminal S1 on the secondary side of the transformer 321, and the terminals S21 and S22 are connected to the terminal S2 on the secondary side of the transformer 321.

According to the second embodiment, the windings w11 and w12 are connected in parallel to each other on the primary side of the transformer 321, and the windings w21 and w22 are connected in parallel to each other on the secondary side of the transformer 321.

The windings w11 and w12 are wound around the core X1 so that when a current flows between the terminals P1 and P2, the windings w11 and w12 generate magnetic fluxes in an identical direction along the loop of the core X1. For example, the windings w11 and w12 are wound around the core X1 so that when a current flows from the terminal P11 towards the terminal P22, and a current flows from the terminal P12 towards the terminal P21, the winding w11 generates magnetic flux in a clockwise direction along the loop of the core X1 (see FIG. 9), and the winding w12 generates magnetic flux in a clockwise direction along the loop of the core X1. The windings w21 and w22 are wound around the core X1 so that when a current flows between the terminals S1 and S2, the windings w21 and w22 generate magnetic fluxes in an identical direction along the loop of the core X1. For example, the windings w21 and w22 are wound around the core X1 so that when a current flows from the terminal S11 towards the terminal S22, and when a current flows from the terminal

S12 towards the terminal S21, the winding w21 generates magnetic flux in a clockwise direction along the loop of the core X1, and the winding w22 generates magnetic flux in a clockwise direction along the loop of the core X1.

The terminals P11 and P21 are provided at equal distances from the side A1 of the core X1 (that is, from the conductor portion 6). The terminals P22 and P12 are provided at equal distances from the side A1 of the core X1. The terminals S11 and S21 are provided at equal distances from the side A1 of the core X1. The terminals S22 and S12 are provided at equal distances from the side A1 of the core X1.

The insulated DC-DC converter 10A has line-to-ground capacitance Cpa between the terminal P11 and the conductor portion 6, and has line-to-ground capacitance Cpa between the terminal P21 and the conductor portion 6. Since the terminals P11 and P21 of the primary windings of the transformer 321 are provided at equal distances from the conductor portion 6, these line-to-ground capacitances are equal to each other. In addition, the insulated DC-DC converter 10A has line-to-ground capacitance Cpb between the terminal P22 and the conductor portion 6, and has line-to-ground capacitance Cpb between the terminal P12 and the conductor portion 6. Since the terminals P22 and P12 of the primary windings of the transformer 321 are provided at equal distances from the conductor portion 6, these line-to-ground capacitances are equal to each other. In addition, the insulated DC-DC converter 10A has line-to-ground capacitance Csa between the terminal S11 and the conductor portion 6, and has line-to-ground capacitance Csa between the terminal S21 and the conductor portion 6. Since the terminals S11 and S21 of the secondary windings of the transformer 321 are provided at equal distances from the conductor portion 6, these line-to-ground capacitances are equal to each other. In addition, the insulated DC-DC converter 10A has the line-to-ground capacitance Csb between the terminal S22 and the conductor portion 6, and has the line-to-ground capacitance Csb between the terminal S12 and the conductor portion 6. Since the terminals S22 and S12 of the secondary windings of the transformer 321 are provided at equal distances from the conductor portion 6, these line-to-ground capacitances are equal to each other.

Since the insulated DC-DC converter 10A of FIG. 8 is provided with the transformer 321 configured as described above, the following conditions are satisfied on the primary side of the transformer 321:

“line-to-ground capacitance seen from node N3”=Cpa+Cpb, and “line-to-ground capacitance seen from node N4”=Cpa+Cpb.

Since the line-to-ground capacitance seen from the node N3 and the line-to-ground capacitance seen from the node N4 can be made equal to each other, the condition of Equation 8 is satisfied, and thus Ipg=0, and therefore, it is possible to reduce the common mode noise generated on the primary side of the transformer 321.

Similarly, since the insulated DC-DC converter 10A of FIG. 8 is provided with the transformer 321 configured as described above, the following conditions are satisfied on the secondary side of the transformer 321:

“line-to-ground capacitance seen from node N5”=Csa+Csb, and “line-to-ground capacitance seen from node N6”=Csa+Csb. Since the line-to-ground capacitance seen from the node N5 and the line-to-ground capacitance seen from the node N6 can be made equal to each other, the condition of Equation 12 is satisfied, and thus Isg=0, and therefore, it is possible to reduce the common mode noise generated on the secondary side of the transformer 321.

FIG. 13 is a graph illustrating a frequency characteristic of a common mode noise generated in the switching power supply apparatus of FIG. 8. Referring to FIG.

13, a solid line indicates a simulation result of the switching power supply apparatus of FIG. 8 (second embodiment), and a broken line indicates a simulation result of the switching power supply apparatus of FIG. 42 (comparison example). With reference to the analytical result of FIG. 13, we will explain an effect of reducing the common mode noise using the switching power supply apparatus of the second embodiment. The same conditions as those of FIG. 5 were set in the simulation of FIG. 13. As can be seen from FIG. 13, the common mode noise of the switching power supply apparatus of FIG. 8 (solid line) is reduced than that of the switching power supply apparatus of FIG. 42 (broken line).

As described above, according to the switching power supply apparatus of the second embodiment, it is possible to cancel the asymmetry of the line-to-ground capacitances at both ends of the primary winding, by providing the windings w11 and w12 wound on the primary side of the transformer 321 as illustrated in FIGS. 9 to 12. In addition, it is possible to cancel the asymmetry of the line-to-ground capacitances at both ends of the secondary winding, by providing the windings w21 and w22 wound on the secondary side of the transformer 321 as illustrated in FIGS. 9 to 12. Thus, the common node noise due to the line-to-ground capacitances of the transformer 321 can be made less likely to occur.

According to the switching power supply apparatus of the second embodiment, the common node noise can be made less likely to occur even in a case of outputting large power than that of the first embodiment, by connecting the windings w11 and w12 in parallel to each other on the primary side of transformer 321, and connecting the windings w21 and w22 in parallel to each other on the secondary side of transformer 321.

Third Embodiment

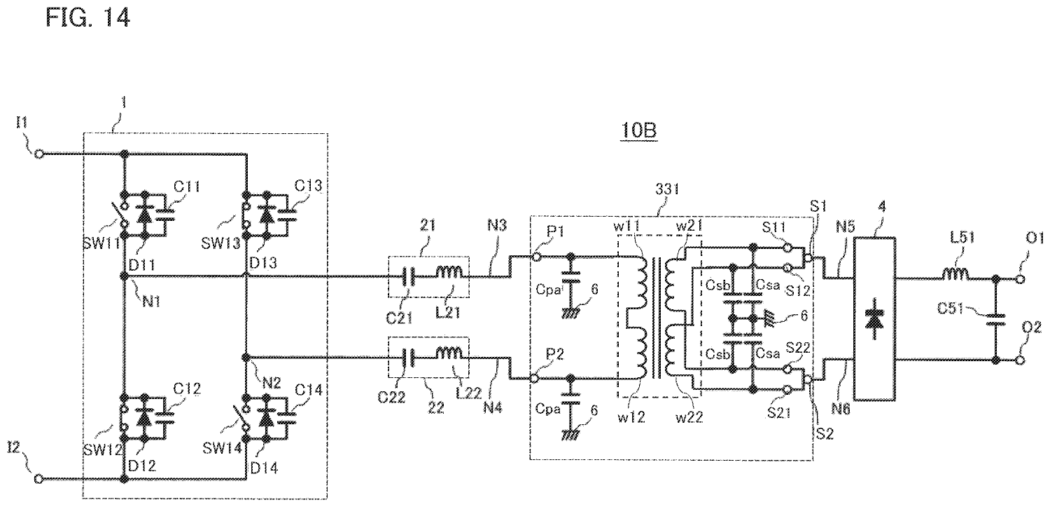

FIG. 14 is a circuit diagram illustrating a configuration of a switching power supply apparatus provided with a transformer 331 of a third embodiment. The switching power supply apparatus of FIG. 14 includes an insulated DC-DC converter 10B. The insulated DC-DC converter 10B is provided with: a full-bridge switching circuit 1, resonant circuits 21 and 22, a transformer 331, a rectifier circuit 4, a smoothing inductor L51, and a smoothing capacitor C51. The insulated DC-DC converter 10B is provided with the transformer 331, in place of the transformer 311 of FIG. 1. The other components of the insulated DC-DC converter 10B, other than the transformer 331, are configured in a manner similar to that of the corresponding components of FIG. 1.

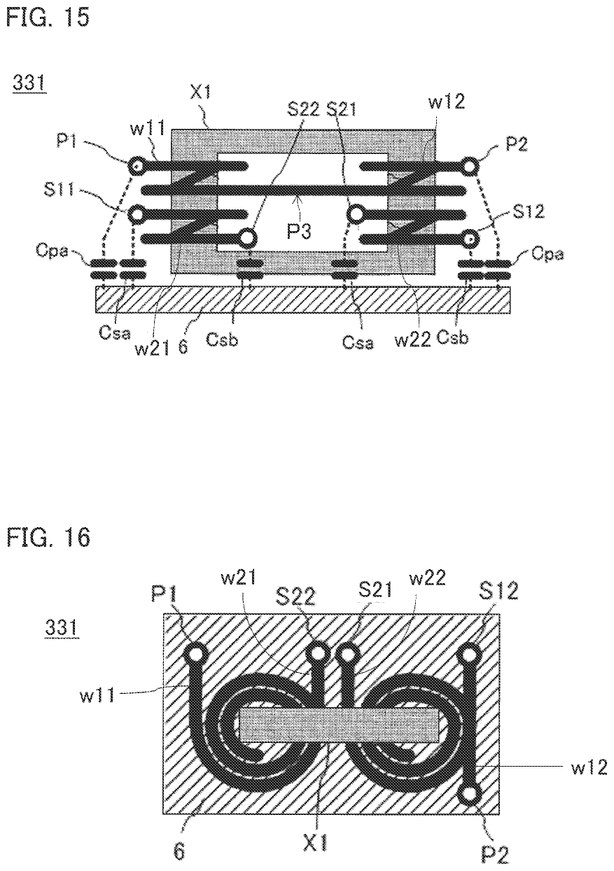

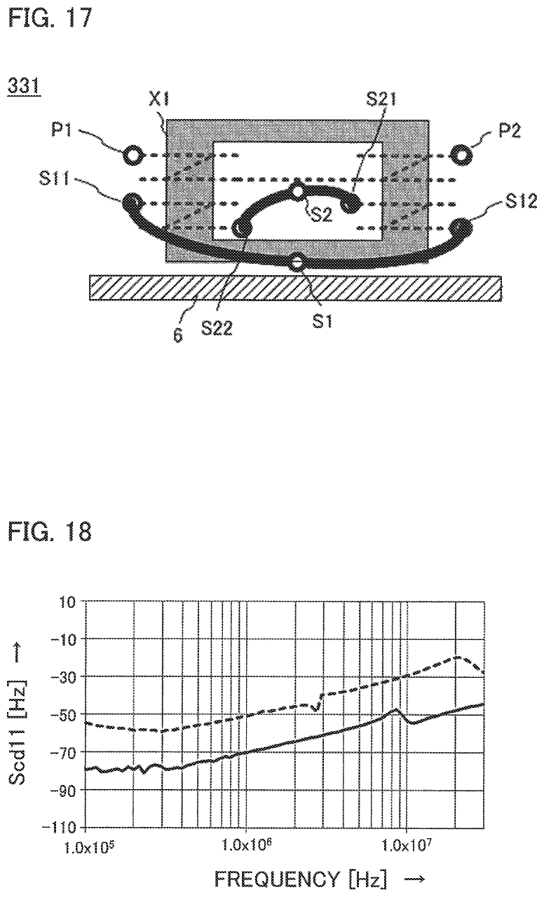

FIG. 15 is a side view illustrating a configuration of the transformer 331 of FIG. 14. FIG. 16 is a top view illustrating the configuration of the transformer 331 of FIG. 14. FIG. 17 illustrates connections of windings w11, w12, w21, and w22 of the transformer 331 of FIG. 14. As illustrated in FIGS. 15 to 17, the transformer 331 is provided with a core X1, primary windings w11 and w12, and secondary windings w21 and w22, and disposed on a conductor portion 6.

The core X1 of FIGS. 15 to 17 is configured in a manner similar to those of the core X1 of FIGS. 2 to 4, the core X2 of FIG. 6, or the core X3 of FIG. 7.

The primary windings w11 and w12 of the transformer 331 of FIGS. 15 to 17 are configured in a manner similar to that of the primary windings w11 and w12 of the transformer 311 of FIGS. 2 to 4. The secondary windings w21 and w22 of the transformer 331 of FIGS. 15 to 17 are configured in a manner similar to that of the secondary windings w21 and w22 of the transformer 321 of FIGS. 9 to 12.

According to the third embodiment, the windings w11 and w12 are connected in series to each other on the primary side of the transformer 331, and the windings w21 and w22 are connected in parallel to each other on the secondary side of the transformer 331.

Since the insulated DC-DC converter 10B of FIG. 14 is provided with the transformer 331 configured as described above, the following conditions are satisfied on the primary side of the transformer 331:

“line-to-ground capacitance seen from node N3”=Cpa, and “line-to-ground capacitance seen from node N4”=Cpa. Since the line-to-ground capacitance seen from the node N3 and the line-to-ground capacitance seen from the node N4 can be made equal to each other, the condition of Equation 8 is satisfied, and thus Ipg=0, and therefore, it is possible to reduce the common mode noise generated on the primary side of the transformer 331.

Similarly, since the insulated DC-DC converter 10B of FIG. 14 is provided with the transformer 331 configured as described above, the following conditions are satisfied on the secondary side of the transformer 331: “line-to-ground capacitance seen from node N5”=Csa+Csb, and “line-to-ground capacitance seen from node N6”=Csa+Csb. Since the line-to-ground capacitance seen from the node N5 and the line-to-ground capacitance seen from the node N6 can be made equal to each other, the condition of Equation 12 is satisfied, and thus Isg=0, and therefore, it is possible to reduce the common mode noise generated on the secondary side of the transformer 331.

FIG. 18 is a graph illustrating a frequency characteristic of a common mode noise generated in the switching power supply apparatus of FIG. 14. Referring to FIG. 18, a solid line indicates a simulation result of the switching power supply apparatus of FIG. 14 (third embodiment), and a broken line indicates a simulation result of the switching power supply apparatus of FIG. 42 (comparison example). With reference to the analytical result of FIG. 18, we will explain an effect of reducing the common mode noise using the switching power supply apparatus of the third embodiment. The same conditions as those of FIG. 5 were set in the simulation of FIG. 18. As can be seen from FIG. 18, the common mode noise of the switching power supply apparatus of FIG. 14 (solid line) is reduced than that of the switching power supply apparatus of FIG.

42 (broken line).

As described above, according to the switching power supply apparatus of the third embodiment, it is possible to cancel the asymmetry of the line-to-ground capacitances at both ends of the primary winding, by providing the windings w11 and w12 wound on the primary side of the transformer 331 as illustrated in FIGS. 15 to 17.

In addition, it is possible to cancel the asymmetry of the line-to-ground capacitances at both ends of the secondary winding, by providing the windings w21 and w22 wound on the secondary side of the transformer 331 as illustrated in FIGS. 15 to 17. Thus, the common node noise due to the line-to-ground capacitances of the transformer 331 can be made less likely to occur.

According to the switching power supply apparatus of the third embodiment, the common node noise can be made less likely to occur even when a larger current flows on the secondary side of transformer 331 than that of the primary side, by connecting the secondary windings of transformer 331 in parallel to each other.

Fourth Embodiment

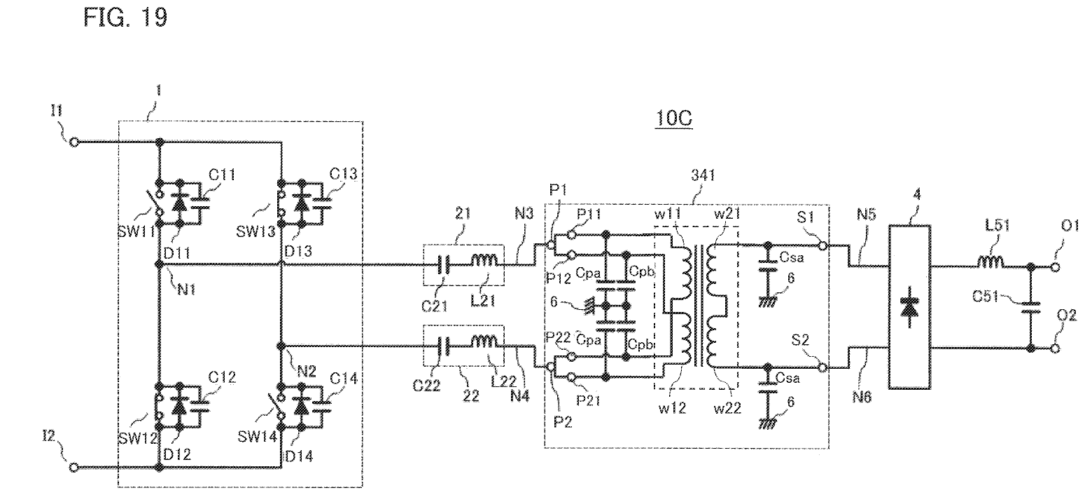

FIG. 19 is a circuit diagram illustrating a configuration of a switching power supply apparatus provided with a transformer 341 according to a fourth embodiment. The switching power supply apparatus of FIG. 19 includes an insulated DC-DC converter 10C. The insulated DC-DC converter 10C is provided with: a full-bridge switching circuit 1, resonant circuits 21 and 22, the transformer 341, a rectifier circuit 4, a smoothing inductor L51, and a smoothing capacitor C51. The insulated DC-DC converter 10C is provided with the transformer 341, in place of the transformer 311 of FIG. 1. The other components of the insulated DC-DC converter 10C, other than the transformer 341, are configured in a manner similar to that of the corresponding components of FIG. 1.

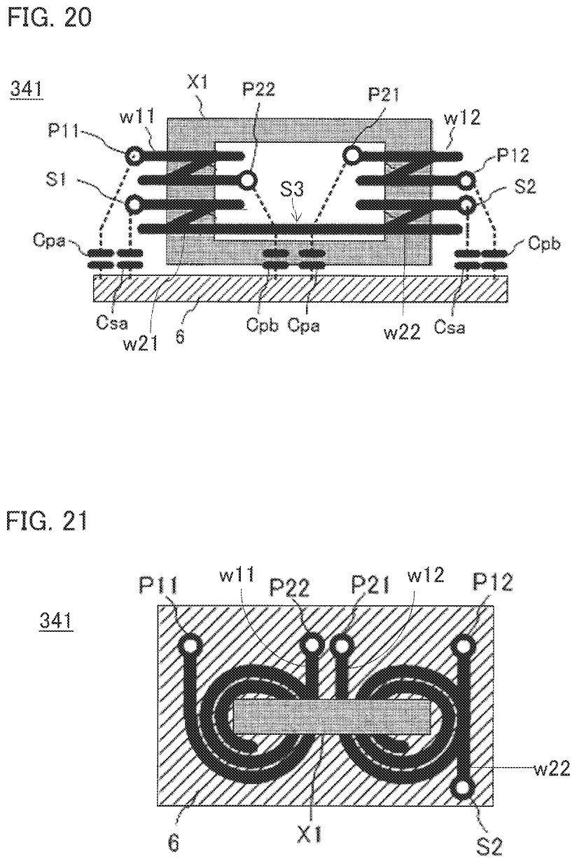

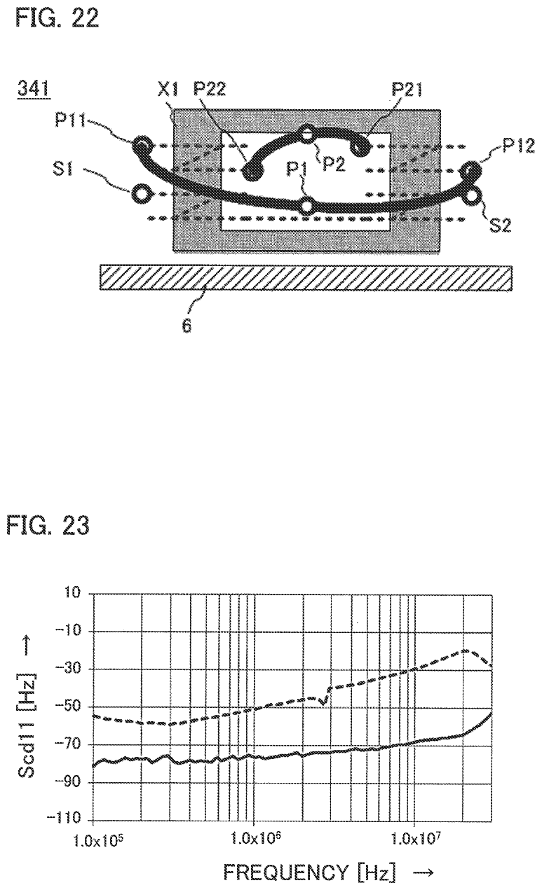

FIG. 20 is a side view illustrating a configuration of the transformer 341 of FIG. 19. FIG. 21 is a top view illustrating the configuration of the transformer 341 of FIG. 19. FIG. 22 illustrates connections of windings w11, w12, w21, and w22 of the transformer 341 of FIG. 19. As illustrated in FIGS. 20 to 22, the transformer 341 is provided with a core X1, primary windings w11 and w12, and secondary windings w21 and w22, and disposed on a conductor portion 6.

The core X1 of FIGS. 20 to 22 is configured in a manner similar to those of the core X1 of FIGS. 2 to 4, the core X2 of FIG. 6, or the core X3 of FIG. 7.

The primary windings w11 and w12 of the transformer 341 of FIGS. 20 to 22 are configured in a manner similar to that of the primary windings w11 and w12 of the transformer 321 of FIGS. 9 to 12. The secondary windings w21 and w22 of the transformer 341 of FIGS. 20 to 22 are configured in a manner similar to that of the secondary windings w21 and w22 of the transformer 311 of FIGS. 2 to 4.

According to the fourth embodiment, the windings w11 and w12 are connected in parallel to each other on the primary side of the transformer 341, and the windings w21 and w22 are connected in series to each other on the secondary side of the transformer 341.

Since the insulated DC-DC converter 10C of FIG. 19 is provided with the transformer 341 configured as described above, the following conditions are satisfied on the primary side of the transformer 341:

“line-to-ground capacitance seen from node N3”=Cpa+Cpb, and “line-to-ground capacitance seen from node N4”=Cpa+Cpb. Since the line-to-ground capacitance seen from the node N3 and the line-to-ground capacitance seen from the node N4 can be made equal to each other, the condition of Equation 8 is satisfied, and thus Ipg=0, and therefore, it is possible to reduce the common mode noise generated on the primary side of the transformer 341.

Similarly, since the insulated DC-DC converter 10C of FIG. 19 is provided with the transformer 341 configured as described above, the following conditions are satisfied on the secondary side of the transformer 341: “line-to-ground capacitance seen from node N5”=Csa, and “line-to-ground capacitance seen from node N6”=Csa. Since the line-to-ground capacitance seen from the node N5 and the line-to-ground capacitance seen from the node N6 can be made equal to each other, the condition of Equation 12 is satisfied, and thus Isg=0, and therefore, it is possible to reduce the common mode noise generated on the secondary side of the transformer 341.

FIG. 23 is a graph illustrating a frequency characteristic of a common mode noise generated in the switching power supply apparatus of FIG. 19. Referring to FIG. 23, a solid line indicates a simulation result of the switching power supply apparatus of FIG. 19 (fourth embodiment), and a broken line indicates a simulation result of the switching power supply apparatus of FIG. 42 (comparison example). With reference to the analytical result of FIG. 23, we will explain an effect of reducing the common mode noise using the switching power supply apparatus of the fourth embodiment. The same conditions as those of FIG. 5 were set in the simulation of FIG. 23. As can be seen from FIG. 23, the common mode noise of the switching power supply apparatus of FIG. 19 (solid line) is reduced than that of the switching power supply apparatus of FIG. 42 (broken line).

As described above, according to the switching power supply apparatus of the fourth embodiment, it is possible to cancel the asymmetry of the line-to-ground capacitances at both ends of the primary winding, by providing the windings w11 and w12 wound on the primary side of the transformer 341 as illustrated in FIGS. 20 to 22.

In addition, it is possible to cancel the asymmetry of the line-to-ground capacitances at both ends of the secondary winding, by providing the windings w21 and w22 wound on the secondary side of the transformer 341 as illustrated in FIGS. 20 to 22. Thus, the common node noise due to the line-to-ground capacitances of the transformer 341 can be made less likely to occur.

According to the switching power supply apparatus of the fourth embodiment, the common node noise can be made less likely to occur even when a higher voltage occurs on the secondary side of transformer 341 than that of the primary side, by connecting the secondary windings of transformer 341 in series to each other.

Fifth Embodiment

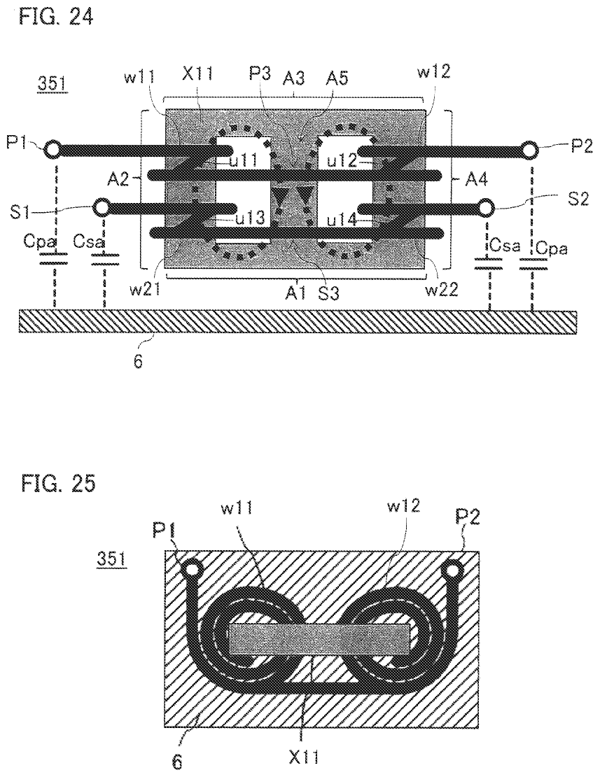

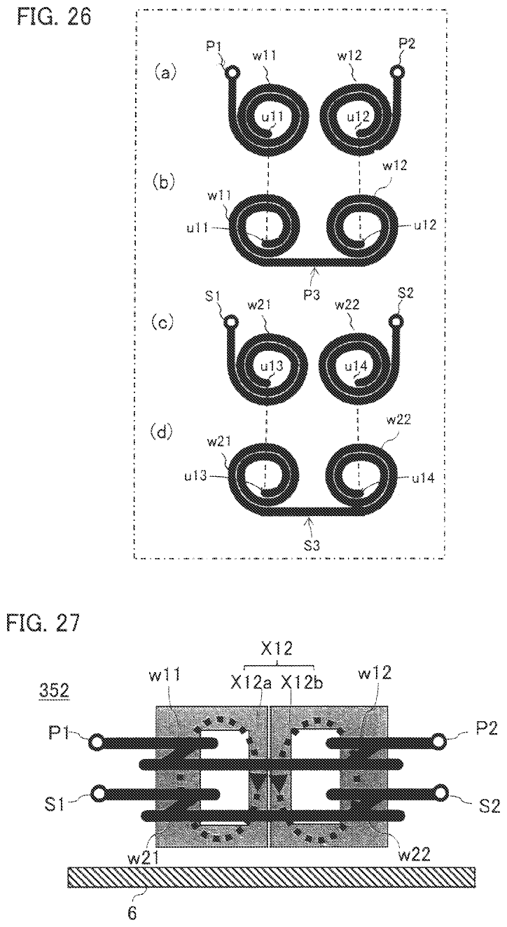

FIG. 24 is a side view illustrating a configuration of a transformer 351 of a fifth embodiment. FIG. 25 is a top view illustrating the configuration of the transformer 351 of FIG. 24. FIG. 26 illustrates an arrangement of windings w11, w12, w21, and w22 of the transformer 351 of FIG. 24. FIG. 26(a) illustrates an arrangement of the windings w11 and w12 in the first layer, FIG. 26(b) illustrates an arrangement of the windings w11 and w12 in the second layer, FIG. 26(c) illustrates an arrangement of the windings w21 and w22 in the third layer, and FIG. 26(d) illustrates an arrangement of the windings w21 and w22 in the fourth layer. As illustrated in FIGS. 24 to 26, the transformer 351 is provided with a core X11, primary windings w11 and w12, and secondary windings w21 and w22, and disposed on a conductor portion 6.

The core X11 has a shape of a rectangular loop having a first side A1 to a fourth side A4, in a manner similar to that of the core X1 of FIG. 2. The core X11 is configured such that the first side A1 and the third side A3 are opposed to each other, and the second side A2 and the fourth side A4 are opposed to each other. The core X11 is further provided with a central section A5 (a portion that extends vertically in

FIG. 24) by which the first side A1 and the third side A3 are magnetically coupled to each other. The side A2, the central section A5, a portion of the side A1 leading from the side A2 to the central section A5, and a portion of the side A3 leading from the side A2 to the central section A5 form a first sub-loop of the core X11. In addition, the side A4, the central section A5, a portion of the side A1 leading from the side A4 to the central section A5, and a portion of the side A3 leading from the side A4 to the central section A5 form a second sub-loop of the core X11. The side A1 and the side A3 of the core X11 are provided in parallel to the conductor portion 6.

The winding w11 is wound around the core X11 on the side A2 of the core X11. The winding w12 is wound around the core X11 on the side A4 of the core X11.

The winding w21 is wound around the core X11 on the side A2 of the core X11. The winding w22 is wound around the core X11 on the side A4 of the core X11. The winding w11 has a first terminal P1 and a second terminal P3. The winding w12 has a third terminal P2 and a fourth terminal P3. The windings w11 and w12 are connected to each other at the terminal P3. The winding w21 has a fifth terminal S1 and a sixth terminal S3. The winding w22 has a seventh terminal S2 and an eighth terminal S3. The windings w21 and w22 are connected to each other at the terminal S3.

According to the fifth embodiment, the windings w11 and w12 may form a single winding, and in this case, a midpoint of the winding is assumed to be the terminal P3. In addition, according to the fifth embodiment, the windings w21 and w22 may be a single winding, and in this case, a midpoint of the winding is assumed to be the terminal S3.

According to the fifth embodiment, the windings w11 and w12 are connected in series to each other on the primary side of the transformer 351, and the windings w21 and w22 are connected in series to each other on the secondary side of the transformer 351.

The windings w11 and w12 are wound around the core X11 so that when a current flows between the terminals P1 and P2, and the winding w11 generates magnetic flux in a clockwise direction (see FIG. 24) along the first sub-loop of the core

X11, the winding w12 generates magnetic flux in a counterclockwise direction (see FIG. 24) along the second sub-loop of the core X11. The windings w21 and w22 are wound around the core X11 so that when a current flows between the terminals S1 and S2, and the winding w21 generates magnetic flux in a clockwise direction along the first sub-loop of the core X1 the winding w22 generates magnetic flux in a counterclockwise direction along the second sub-loop of the core X11.

The windings w11 and w12 are wound around the core X11 at equal distances from the side A1 of the core X11 (that is, from the conductor portion 6). The terminals P1 and P2 are provided at equal distances from the side A1 of the core X11. The windings w21 and w22 are wound around the core X11 at equal distances from the side A1 of the core X11. The terminals S1 and S2 are provided at equal distances from the side A1 of the core X11.

The transformer 351 is applicable to a switching power supply apparatus, in a manner similar to those of the transformer 311 of FIG. 1 and others. The switching power supply apparatus has line-to-ground capacitance between the terminal P1 and the conductor portion 6, and has line-to-ground capacitance between the terminal P2 and the conductor portion 6. Since the terminals P1 and P2 of the primary windings of the transformer 351 are provided at equal distances from the conductor portion 6, these line-to-ground capacitances are equal to each other. In addition, the switching power supply apparatus has line-to-ground capacitance between the terminal S1 and the conductor portion 6, and has line-to-ground capacitance between the terminal S2 and the conductor portion 6. Since the terminals S1 and S2 of the secondary windings of the transformer 351 are provided at equal distances from the conductor portion 6, these line-to-ground capacitances are equal to each other.

When the switching power supply apparatus is provided with the transformer 351 configured as described above, the line-to-ground capacitance seen from the node N3 and the line-to-ground capacitance seen from the node N4 can be made equal to each other on the primary side of the transformer 351. Hence, the condition of Equation 8 is satisfied, and thus Ipg=0, and therefore, it is possible to reduce the common mode noise generated on the primary side of the transformer 351.

Similarly, when the switching power supply apparatus is provided with the transformer 351 configured as described above, the line-to-ground capacitance seen from the node N5 and the line-to-ground capacitance seen from the node N6 can be made equal to each other on the secondary side of the transformer 351. Hence, the condition of Equation 12 is satisfied, and thus Isg=0, and therefore, it is possible to reduce the common mode noise generated on the secondary side of the transformer 351.

As described above, according to the transformer and the switching power supply apparatus of the fifth embodiment, it is possible to cancel the asymmetry of the line-to-ground capacitances at both ends of the primary winding, by providing the windings w11 and w12 wound on the primary side of the transformer 351 as illustrated in FIGS. 24 to 26. In addition, it is possible to cancel the asymmetry of the line-to-ground capacitances at both ends of the secondary winding, by providing the windings w21 and w22 wound on the secondary side of the transformer 351 as illustrated in FIGS. 24 to 26. Thus, the common node noise due to the line-to-ground capacitances of the transformer 351 can be made less likely to occur.

FIG. 27 is a side view illustrating a configuration of a transformer 352 according to a first modified embodiment of the fifth embodiment. The transformer 352 of FIG. 27 is provided with a core X12 made of two core portions X12a and X12b, in place of the core X11 of FIG. 24. By providing a gap between the core portions

X12a and X12b, magnetic saturation in the core X12 can be made less likely to occur. The core X12 may have only one gap, or two or more gaps, along the loop thereof. In addition, by using the core X12 split into two core portions X12a and X12b, it is possible to more easily wind the windings around the core, as compared with the case of using a loop-shaped integrated core, thus facilitating manufacturing of the transformer. In addition, by inserting a radiator between the core portions X12a and X12b, it is possible to improve cooling performance of the transformer 352.

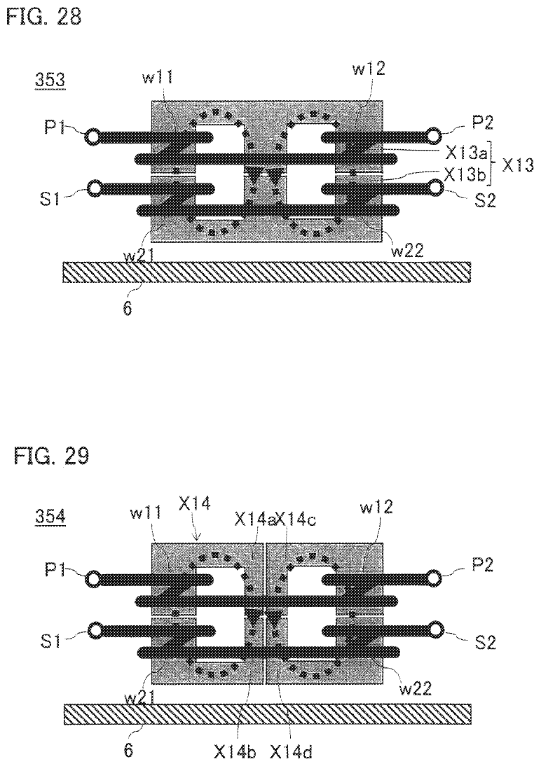

FIG. 28 is a side view illustrating a configuration of a transformer 353 according to a second modified embodiment of the fifth embodiment. The transformer 353 of FIG. 28 is provided with a core X13 made of two core portions X13a and X13b, in place of the core X11 of FIG. 24. By providing gaps between the core portions X13a and X13b, magnetic saturation in the core X13 can be made less likely to occur. The core X13 may have only one gap, or two or more gaps, along the loop thereof. In addition, by using the core X13 split into two core portions X13a and X13b, it is possible to more easily wind the windings around the core, as compared with the case of using a loop-shaped integrated core, thus facilitating manufacturing of the transformer. In addition, by inserting radiators between the core portions X13a and X13b, it is possible to improve cooling performance of the transformer 353.

FIG. 29 is a side view illustrating a configuration of a transformer 354 according to a third modified embodiment of the fifth embodiment. The transformer 354 of FIG. 29 is provided with a core X14 made of four core portions X14a to X14d, in place of the core X11 of FIG. 24. By providing gaps among the core portions X14a to X14d, magnetic saturation in the core X14 can be made less likely to occur. The core X14 may have only one gap, or two or more gaps, along the loop thereof. In addition, by using the core X14 split into four core portions X14a to X14d, it is possible to more easily wind the windings around the core, as compared with the case of using a loop-shaped integrated core, thus facilitating manufacturing of the transformer. In addition, by inserting radiators among the core portions X14a to X14d, it is possible to improve cooling performance of the transformer 354.

Sixth Embodiment

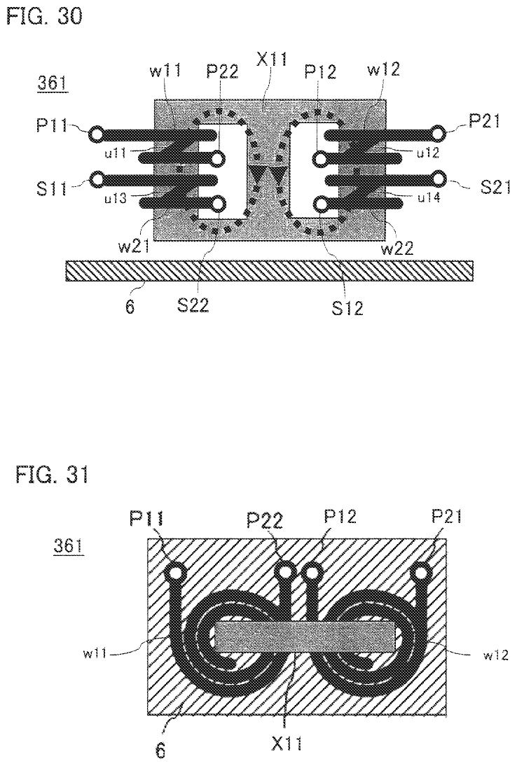

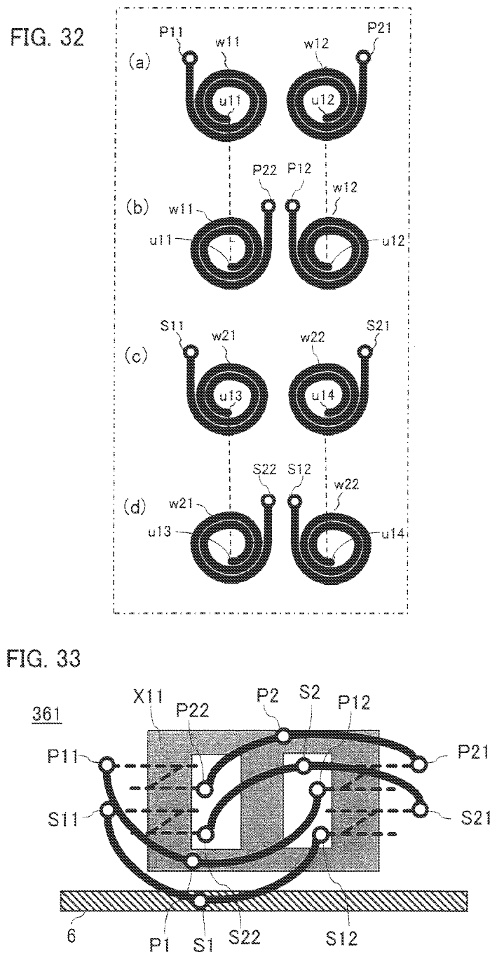

FIG. 30 is a side view illustrating a configuration of a transformer 361 of a sixth embodiment. FIG. 31 is a top view illustrating the configuration of the transformer 361 of FIG. 30. FIG. 32 illustrates an arrangement of windings w11, w12, w21, and w22 of the transformer 361 of FIG. 30. FIG. 32(a) illustrates an arrangement of the windings w11 and w12 in the first layer, FIG. 32(b) illustrates an arrangement of the windings w11 and w12 in the second layer, FIG. 32(c) illustrates an arrangement of the windings w21 and w22 in the third layer, and FIG. 32(d) illustrates an arrangement of the windings w21 and w22 in the fourth layer. FIG. 33 illustrates connections of the windings w11, w12, w21, and w22 of the transformer 361 of FIG. 30. As illustrated in FIGS. 30 to 33, the transformer 361 is provided with a core X11, primary windings w11 and w12, and secondary windings w21 and w22, and disposed on a conductor portion 6.

The core X11 of FIGS. 30 to 33 is configured in a manner similar to those of the core X11 of FIGS. 24 to 26, the core X12 of FIG. 27, the core X13 of FIG. 28, or the core X14 of FIG. 29.

Each of the windings w11, w12, w21, and w22 of FIGS. 30 to 33 is wound at a similar position as that of the corresponding winding w11, w12, w21, or w22 of FIGS. 24 to 26 on the corresponding side of the core X11. The winding w11 has a first terminal P11 and a second terminal P22. The winding w12 has a third terminal P21 and a fourth terminal P12. The winding w21 has a fifth terminal S11 and a sixth terminal S22. The winding w22 has a seventh terminal S21 and an eighth terminal S12.

Referring to FIG. 33, the windings w11 and w12 are connected to each other at the terminals P11 and P12, and connected to each other at the terminals P22 and P21. The terminals P11 and P12 are connected to the terminal P1 on the primary side of the transformer 361, and the terminals P21 and P22 are connected to the terminal P2 on the primary side of the transformer 361. In addition, the windings w21 and w22 are connected to each other at the terminals S11 and S12, and connected to each other at the terminals S22 and S21. The terminals S11 and S12 are connected to the terminal S1 on the secondary side of the transformer 361, and the terminals S21 and S22 are connected to the terminal S2 on the secondary side of the transformer 361.

According to the sixth embodiment, the windings w11 and w12 are connected in parallel to each other on the primary side of the transformer 361, and the windings w21 and w22 are connected in parallel to each other on the secondary side of the transformer 361.

The windings w11 and w12 are wound around the core X11 so that when a current flows between the terminals P1 and P2, and the winding w11 generates magnetic flux in a clockwise direction (see FIG. 30) along the first sub-loop of the core X11, the winding w12 generates magnetic flux in a counterclockwise direction (see FIG.

30) along the second sub-loop of the core X11. The windings w21 and w22 are wound around the core X11 so that when a current flows between the terminals S1 and S2, and the winding w21 generates magnetic flux in a clockwise direction along the first sub-loop of the core X11, the winding w22 generates magnetic flux in a counterclockwise direction along the second sub-loop of the core X11.

The terminals P11 and P21 are provided at equal distances from the side A1 of the core X11 (that is, from the conductor portion 6). The terminals P22 and P12 are provided at equal distances from the side A1 of the core X11. The terminals S11 and S21 are provided at equal distances from the side A1 of the core X11. The terminals S22 and S12 are provided at equal distances from the side A1 of the core X11.

The transformer 361 is applicable to a switching power supply apparatus, in a manner similar to those of the transformer 311 of FIG. 1 and others. The switching power supply apparatus has line-to-ground capacitance between the terminal P11 and the conductor portion 6, and has line-to-ground capacitance between the terminal P21 and the conductor portion 6. Since the terminals P11 and P21 of the primary windings of the transformer 361 are provided at equal distances from the conductor portion 6, these line-to-ground capacitances are equal to each other. In addition, the switching power supply apparatus has line-to-ground capacitance between the terminal P22 and the conductor portion 6, and has line-to-ground capacitance between the terminal P12 and the conductor portion 6. Since the terminals P22 and

P12 of the primary windings of the transformer 361 are provided at equal distances from the conductor portion 6, these line-to-ground capacitances are equal to each other. In addition, the switching power supply apparatus has line-to-ground capacitance between the terminal S11 and the conductor portion 6, and has line-to-ground capacitance between the terminal S21 and the conductor portion 6. Since the terminals S11 and S21 of the secondary windings of the transformer 361 are provided at equal distances from the conductor portion 6, these line-to-ground capacitances are equal to each other. In addition, the switching power supply apparatus has line-to-ground capacitance between the terminal S22 and the conductor portion 6, and has line-to-ground capacitance between the terminal S12 and the conductor portion 6.

Since the terminals S22 and S12 of the secondary windings of the transformer 361 are provided at equal distances from the conductor portion 6, these line-to-ground capacitances are equal to each other.

When the switching power supply apparatus is provided with the transformer 361 configured as described above, the line-to-ground capacitance seen from the node N3 and the line-to-ground capacitance seen from the node N4 can be made equal to each other on the primary side of the transformer 361. Hence, the condition of Equation 8 is satisfied, and thus Ipg=0, and therefore, it is possible to reduce the common mode noise generated on the primary side of the transformer 361.

Similarly, when the switching power supply apparatus is provided with the transformer 361 configured as described above, the line-to-ground capacitance seen from the node N5 and the line-to-ground capacitance seen from the node N6 can be made equal to each other on the secondary side of the transformer 361. Hence, the condition of Equation 12 is satisfied, and thus Isg=0, and therefore, it is possible to reduce the common mode noise generated on the secondary side of the transformer 361.

As described above, according to the transformer and the switching power supply apparatus of the sixth embodiment, it is possible to can cancel the asymmetry of the line-to-ground capacitances at both ends of the primary winding, by providing the windings w11 and w12 wound on the primary side of the transformer 361 as illustrated in FIGS. 30 to 33. In addition, it is possible to cancel the asymmetry of the line-to-ground capacitances at both ends of the secondary winding, by providing the windings w21 and w22 wound on the secondary side of the transformer 361 as illustrated in FIGS. 30 to 33. Thus, the common node noise due to the line-to-ground capacitances of the transformer 361 can be made less likely to occur.

According to the switching power supply apparatus of the sixth embodiment, the common mode noise can be made less likely to occur even in a case of outputting large power than that of the first embodiment, by connecting the windings w11 and w12 in parallel to each other on the primary side of the transformer 361, and connecting the windings w21 and w22 in parallel to each other on the secondary side of the transformer 361.

Seventh Embodiment

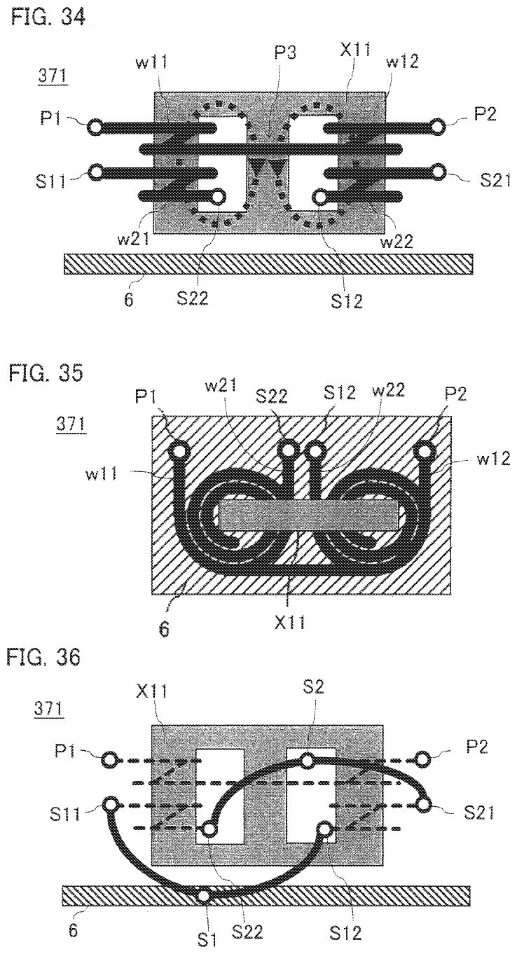

FIG. 34 is a side view illustrating a configuration of a transformer 371 of a seventh embodiment. FIG. 35 is a top view illustrating the configuration of the transformer 371 of FIG. 34. FIG. 36 illustrates connections of windings w11, w12, w21, and w22 of the transformer 371 of FIG. 34. As illustrated in FIGS. 34 to 36, the transformer 371 is provided with a core X11, primary windings w11 and w12, and secondary windings w21 and w22, and disposed on a conductor portion 6.

The core X11 of FIGS. 34 to 36 is configured in a manner similar to those of the core X11 of FIGS. 24 to 26, the core X12 of FIG. 27, the core X13 of FIG. 28, or the core X14 of FIG. 29.

The primary windings w11 and w12 of the transformer 371 of FIGS. 34 to 36 are configured in a manner similar to that of the primary windings w11 and w12 of the transformer 351 of FIGS. 24 to 26. The secondary windings w21 and w22 of the transformer 371 of FIGS. 34 to 36 are configured in a manner similar to that of the secondary windings w21 and w22 of the transformer 361 of FIGS. 30 to 33.

According to the seventh embodiment, the windings w11 and w12 are connected in series to each other on the primary side of the transformer 371, and the windings w21 and w22 are connected in parallel to each other on the secondary side of the transformer 371.

When a switching power supply apparatus is provided with the transformer 371 configured as described above, the line-to-ground capacitance seen from the node N3 and the line-to-ground capacitance seen from the node N4 can be made equal to each other on the primary side of the transformer 371. Hence, the condition of Equation 8 is satisfied, and thus Ipg=0, and therefore, it is possible to reduce the common mode noise generated on the primary side of the transformer 371.

Similarly, when a switching power supply apparatus is provided with the transformer 371 configured as described above, the line-to-ground capacitance seen from the node N5 and the line-to-ground capacitance seen from the node N6 can be made equal to each other on the secondary side of the transformer 371. Hence, the condition of Equation 12 is satisfied, and thus Isg=0, and therefore, it is possible to reduce the common mode noise generated on the secondary side of the transformer 371.

As described above, according to the switching power supply apparatus of the seventh embodiment, it is possible to cancel the asymmetry of the line-to-ground capacitances at both ends of the primary winding, by providing the windings w11 and w12 wound on the primary side of transformer 371 as illustrated in FIGS. 34 to 36. In addition, it is possible to cancel the asymmetry of the line-to-ground capacitances at both ends of the secondary winding, by providing the windings w21 and w22 wound on the secondary side of the transformer 371 as illustrated in FIGS. 34 to 36. Thus, the common node noise due to the line-to-ground capacitances of the transformer 371 can be made less likely to occur.

According to the switching power supply apparatus of the seventh embodiment, the common node noise can be made less likely to occur even when a larger current flows on the secondary side of transformer 371 than that of the primary side, by connecting the secondary windings of transformer 371 in parallel to each other.

Eighth Embodiment

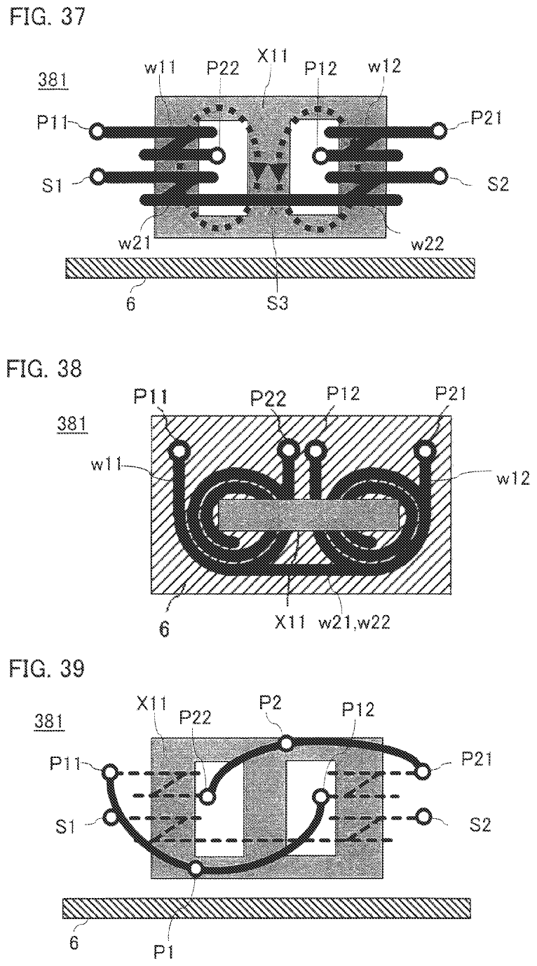

FIG. 37 is a side view illustrating a configuration of a transformer 381 according to an eighth embodiment. FIG. 38 is a top view illustrating the configuration of the transformer 381 of FIG. 37. FIG. 39 illustrates connections of windings w11, w12, w21, and w22 of the transformer 381 of FIG. 37. As illustrated in FIGS. 37 to 39, the transformer 381 is provided with a core X11, primary windings w11 and w12, and secondary windings w21 and w22, and disposed on a conductor portion 6.

The core X11 of FIGS. 37 to 39 is configured in a manner similar to those of the core X11 of FIGS. 24 to 26, the core X12 of FIG. 27, the core X13 of FIG. 28, or the core X14 of FIG. 29.

The primary windings w11 and w12 of the transformer 381 of FIGS. 37 to 39 are configured in a manner similar to that of the primary windings w11 and w12 of the transformer 361 of FIGS. 30 to 33. The secondary windings w21 and w22 of the transformer 381 of FIGS. 37 to 39 are configured in a manner similar to that of the secondary windings w21 and w22 of the transformer 351 of FIGS. 24 to 26.

According to the eighth embodiment, the windings w11 and w12 are connected in parallel to each other on the primary side of the transformer 381, and the windings w21 and w22 are connected in series to each other on the secondary side of the transformer 381.

When a switching power supply apparatus is provided with the transformer 381 configured as described above, the line-to-ground capacitance seen from the node N3 and the line-to-ground capacitance seen from the node N4 can be made equal to each other on the primary side of the transformer 381. Hence, the condition of Equation 8 is satisfied, and thus Ipg=0, and therefore, it is possible to reduce the common mode noise generated on the primary side of the transformer 381.

Similarly, when a switching power supply apparatus is provided with the transformer 381 configured as described above, the line-to-ground capacitance seen from the node N5 and the line-to-ground capacitance seen from the node N6 can be made equal to each other on the secondary side of the transformer 381. Hence, the condition of Equation 12 is satisfied, and thus Isg=0, and therefore, it is possible to reduce the common mode noise generated on the secondary side of the transformer 381.

As described above, according to the switching power supply apparatus of the eighth embodiment, it is possible to cancel the asymmetry of the line-to-ground capacitances at both ends of the primary winding, by providing the windings w11 and w12 wound on the primary side of transformer 381 as illustrated in FIGS. 37 to 39. In addition, it is possible to cancel the asymmetry of the line-to-ground capacitances at both ends of the secondary winding, by providing the windings w21 and w22 wound on the secondary side of the transformer 381 as illustrated in FIGS. 37 to 39. Thus, the common node noise due to the line-to-ground capacitances of the transformer 381 can be made less likely to occur.

According to the switching power supply apparatus of the eighth embodiment, the common node noise can be made less likely to occur even when a higher voltage occurs on the secondary side of transformer 381 than that of the primary side, by connecting the secondary windings of transformer 381 in series to each other.

Ninth Embodiment

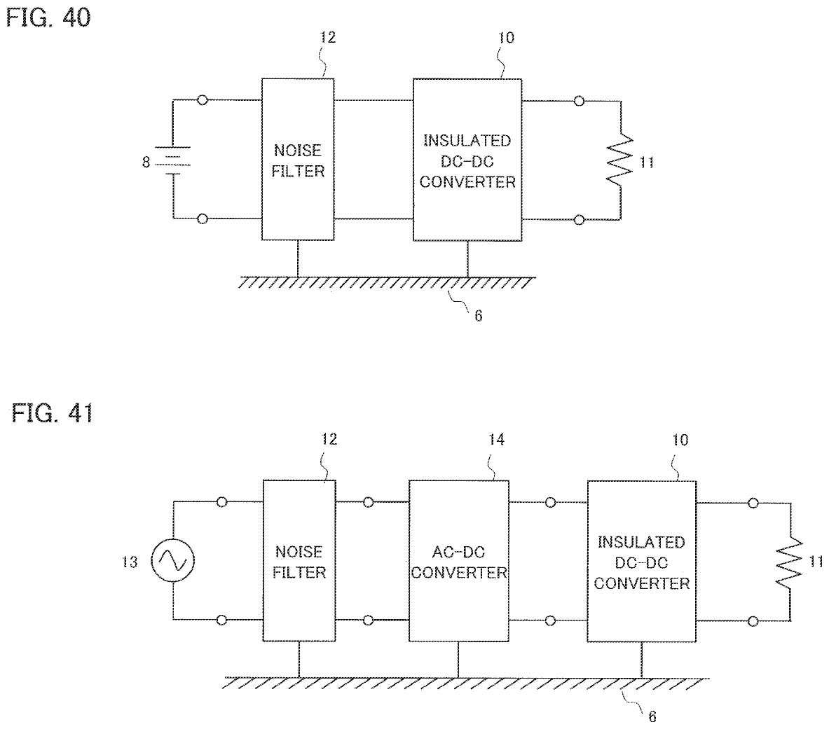

FIG. 40 is a block diagram illustrating a configuration of a switching power supply apparatus according to a ninth embodiment. The switching power supply apparatus of FIG. 40 is provided with the insulated DC-DC converter 10 of FIG. 1, and a noise filter 12. The noise filter 12 removes normal mode noises flowing in a bus of the switching power supply apparatus. The noise filter 12 is provided with a low-pass filter or a band-pass filter, for example, for removing noises generated by operations of the switching circuit 1. Although the switching power supply apparatuses of the first to eighth embodiments can make the common mode noise less likely to occur, they can not reduce the normal mode noise. On the other hand, since the switching power supply apparatus of FIG. 40 it provided with the noise filter 12, it is possible to reduce both the common mode noise and the normal mode noise.

FIG. 41 is a block diagram illustrating a configuration of a switching power supply apparatus according to a modified embodiment of the ninth embodiment. The switching power supply apparatus of FIG. 41 is provided with the insulated DC-DC converter 10 of FIG. 1, a noise filter 12, and an AC-DC converter 14. The AC-DC converter 14 converts AC voltage of an AC power supply 13, such as a commercial power supply, into DC voltage, and supplies the DC voltage to the insulated DC-DC converter 10. The noise filter 12 removes normal mode noises flowing in a bus of the switching power supply apparatus. Since the switching power supply apparatus of FIG. 41 is provided with the noise filter 12, it is possible to reduce both the common mode noise and the normal mode noise, and can make the common mode noise and the normal mode noise less likely to propagate to the AC power supply 13.

[Other Modified Embodiments]

Although FIGS. 2 to 4 exemplify the case in which the distance from the terminals P1, P2 to the conductor portion 6 is longer than the distance from the terminal P3 to the conductor portion 6, the terminals P1 to P3 may be arranged at different positions, as long as it is possible to cancel the asymmetry of the line-to-ground capacitances at both ends of the primary winding. For example, the distance from the terminal P3 to the conductor portion 6 may be longer than the distance from the terminals P1, P2 to the conductor portion 6. Similarly, although FIGS. 2 to 4 exemplify the case in which the distance from the terminals S1, S2 to the conductor portion 6 is longer than the distance from the terminal S3 to the conductor portion 6, the terminals S1 to S3 may be arranged at different positions, as long as it is possible to cancel the asymmetry of the line-to-ground capacitances at both ends of the secondary winding. For example, the distance from the terminal S3 to the conductor portion 6 may be longer than the distance from the terminals S1, S2 to the conductor portion 6. In addition, although FIGS. 9 to 12 exemplify the case in which the distance from the terminals P11 and P21 to the conductor portion 6 is longer than the distance from the terminals P22 and P12 to the conductor portion 6, the terminals P11 to P22 may be arranged at different positions, as long as it is possible to cancel the asymmetry of the line-to-ground capacitances at both ends of the primary winding.

For example, the distance from the terminals P22 and P12 to the conductor portion 6 may be longer than the distance from the terminals P11 and P21 to the conductor portion 6. Similarly, although FIGS. 9 to 12 exemplify the case in which the distance from the terminals S11 and S21 to the conductor portion 6 is longer than the distance from the terminals S22 and S12 to the conductor portion 6, the terminals S11 to S22 may be arranged at different positions, as long as it is possible to cancel the asymmetry of the line-to-ground capacitances at both ends of the secondary winding. For example, the distance from the terminals S22 and S12 to the conductor portion 6 may be longer than the distance from the terminals S11 and S21 to the conductor portion 6. The same also applies to embodiments other than the first and second embodiments.

In addition, although FIGS. 2 to 4 exemplify the case in which the distance from the primary windings w11 and w12 to the conductor portion 6 is longer than the distance from the secondary windings w21 and w22 to the conductor portion 6, the windings w11, w12, w21, w22 may be arranged at different positions, as long as it is possible to cancel the asymmetry of the line-to-ground capacitances at both ends of the primary winding and at both ends of the secondary winding. For example, the distance from the secondary windings w21 and w22 to the conductor portion 6 may be longer than the distance from the primary windings w11 and w12 to the conductor portion 6. The same also applies to embodiments other than the first embodiment.

In addition, the windings w11 and w12 may be wound in a direction different from that exemplified above, as long as it is possible to cancel the asymmetry of the line-to-ground capacitances at both ends of the primary winding. Similarly, the windings w21 and w22 may be wound in a direction different from that exemplified above, as long as it is possible to cancel the asymmetry of the line-to-ground capacitances at both ends of the secondary winding.

In addition, although the core-type transformers are exemplified in the illustrated embodiments, the transformer may be of shell-type.

In addition, the illustrated embodiments exemplify the case in which the primary winding is divided into two windings w11 and w12, the primary winding may be divided into a larger number of windings. The divided windings are connected to each other so as to cancel the asymmetry of the line-to-ground capacitances at both ends of the primary winding. Similarly, the illustrated embodiments exemplify the case in which the secondary winding is divided into two windings w21 and w22, the secondary winding may be divided into a larger number of windings. The divided windings are connected to each other so as to cancel the asymmetry of the line-to-ground capacitances at both ends of the secondary winding.

In addition, although FIG. 1 and others exemplify the cases in which the resonant circuits 21 and 22 include the resonant inductors L21 and L22, the resonant circuits 21 and 22 may be configured using leakage inductance and excitation inductance of the transformer 3.

In addition, FIG. 1 and others exemplify the LLC-resonance DC-DC converter provided with the resonant circuits 21 and 22, the embodiments of the present disclosure are also applicable to a DC-DC converter without the resonant circuits 21 and 22.

### INDUSTRIAL APPLICABILITY

The switching power supply apparatus according to the present disclosure is useful for realizing an insulated DC-DC converter with low noise, small size, and low cost, for use in industrial, on-board, or medical switching power supply apparatus or the like.

1. A transformer comprising:
a core having a shape of a rectangular loop having first to fourth sides, wherein the first and third sides are opposed to each other, and the second and fourth sides are opposed to each other;
a first winding wound around the core on the second side of the core,
a second winding wound around the core on the fourth side of the core;
a third winding wound around the core on the second side of the core; and
a fourth winding wound around the core on die fourth side of the core,
wherein the first and second windings are wound around die core at equal distances from die first side of the core,
wherein the third and fourth windings are wound around the core at equal distances from the first side of the core,
wherein the first and second windings are connected in series or in parallel to each other, and
wherein the third and fourth windings are connected in series or in parallel to each other.

2. The transformer according to claim 1,
wherein the first winding has a first and a second terminals,
wherein the second winding has a third and a fourth terminals,
wherein the third winding has a fifth and a sixth terminals,
wherein the fourth winding has a seventh and an eighth terminals, and
wherein the first and third terminals are provided at equal distances from the first side of the core,
wherein the second and fourth terminals are provided at equal distances from the first side of the core,
wherein the fifth and seventh terminals are provided at equal distances from the first side of the core, and
wherein the sixth and eighth terminals are provided at equal distances from the first side of the core.

3. The transformer according to cl aim 2,
wherein the first and second windings are connected to each other at the second and fourth terminals,
wherein the first and second windings are wound around the core so that when a current flows between the first and third terminals, the first and second windings generate magnetic fluxes in an identical direction along the loop of the core,
wherein the third and fourth windings are connected to each other at the sixth and eighth terminals, and
wherein the third and fourth windings are wound around the core so that when a current flows between the fifth and seventh terminals, the third and fourth windings generate magnetic fluxes in an identical direction along the loop of tire core.

4. The transformer according to claim 2,
wherein the first and second windings are connected to each other at the second and fourth terminals,
wherein the first and second windings are wound around the core so that when a current flows between the first and third terminals, the first and second windings generate magnetic fluxes in an identical direction along the loop of the core,
wherein the third and fourth windings are connected to each other at the fifth and eighth terminals, and connected to each other at the sixth and seventh terminals, and
wherein the third and fourth windings are wound around the core so that when a current flows between the fifth and sixth terminals, the third and fourth windings generate magnetic fluxes in an identical direction along the loop of the core.

5. The transformer according to claim 2,
wherein the first and second windings are connected to each other at the first and fourth terminals, and connected to each other at the second and third terminals,
wherein the first and second windings are wound around the core so that when a current flows between the first and second terminals, the first and second windings generate magnetic fluxes in an identical direction along the loop of the core,
wherein the third and fourth windings are connected to each other at the fifth and eighth terminals, and connected to each other at the sixth and seventh terminals, and
wherein the third and fourth windings are wound around the core so that when a current flows between the fifth and sixth terminals, the third and fourth windings generate magnetic fluxes in an identical direction along the loop of the core.

6. The transformer according to claim 1,
wherein the core further comprises a central section by which the first and third sides are magnetically coupled to each other,
wherein the second side, the central section, a portion of the first side leading from the second side to the central section, and a portion of the third side leading from the second side to the central section form a first sub-loop, and
wherein the fourth side, the central section, a portion of the first side leading from the fourth side to the central section, and a portion of tire third side leading from the fourth side to tire central section form a second sub-loop.

7. The transformer according to claim 6,
wherein the first winding has a first and a second terminals,
wherein the second winding has a third and a fourth terminals,
wherein die third winding has a fifth and a sixth terminals,
wherein the fourth winding has a seventh and an eighth terminals,
wherein the first and third terminals are provided at equal distances from the first side of the core,
wherein the second and fourth terminals are provided at equal distances from the first side of the core, and
wherein the fifth and seventh terminals are provided at equal distances from the first side of the core, and
wherein the sixth and eighth terminals are provided at equal distances from the first side of the core.

8. The transformer according to claim 7,
wherein the first and second windings are connected to each other at the second and fourth terminals,
wherein the first and second windings are wound around the core so that when a current flows between die first and third terminals, and the first winding generates magnetic flux in a clock wise direction along the first sub-loop of the core, the second winding generates magnetic flux in a counterclockwise direction along the second sub-loop of the core,
wherein the third and fourth windings are connected to each other at the sixth and eighth terminals, and
wherein the third and fourth windings are wound around the core so that when a current flows between the fifth and seventh terminals, and the third winding generates magnetic flux in die clockwise direction along die first sub-loop of die core, the fourth winding generates magnetic flux in the counterclockwise direction along the second sub-loop of the core.

9. The transformer according to claim 7,
wherein the first and second windings are connected to each other at the second and fourth terminals,
wherein the first and second windings are wound around the core so that when a current flows between the first and third terminals, and the first winding generates magnetic flux in a clockwise direction along the first sub-loop of the core, the second winding generates magnetic flux in a counterclockwise direction along the second sub-loop of the core,
wherein the third and fourth windings are connected to each other at the fifth and eighth terminals, and connected to each other at the sixth and seventh terminals, and
wherein the third and fourth windings are wound around the core so that when a current flows between the fifth and sixth terminals, and the third winding generates magnetic flux in the clock wise direction along the first sub-loop of the core, the fourth winding generates a magnetic flux in the counterclockwise direction along the second sub-loop of the core.

10. The transformer according to claim 7,
wherein the first and second windings are connected to each other at the first and fourth terminals, and connected to each other at the second and third terminals,
wherein the first and second windings are wound around the core so that when a current flows between the first and second terminals, and the first winding generates magnetic flux in a clock wise direction along the first sub-loop of the core, the second winding generates magnetic flux in a counterclockwise direction along the second sub-loop of the core,
wherein the third and fourth windings are connected to each other at the fifth and eighth terminals, and connected to each other at the sixth and seventh terminals, and
wherein the third and fourth windings are wound around the core so that when a current flows between the fifth and sixth terminals, and the third winding generates magnetic flux in the clockwise direction along the first sub-loop of the core, the fourth winding generates magnetic flux in the counterclockwise direction along the second sub-loop of the core.

11. A switching power supply apparatus comprising:
a switching circuit including a plurality of switching elements that form a bridge circuit; and
a transformer,
wherein the transformer comprises:
a core having a shape of a rectangular loop having first to fourth sides, wherein the first and third sides are opposed to each other, and the second and fourth sides are opposed to each other:
a first winding wound around the core on the second side of the core
a second winding wound around the core on the fourth side of the core,
a third winding wound around the core on the second side of the core: and
a fourth winding wound around the core on the fourth side of the core,
wherein the first and second windings are wound around the core at equal distances from the first side of the core.
wherein the third and fourth windings are wound around the core at equal distances from the first side of the core
wherein the first and second windings are connected in series or in parallel to each other, and
wherein the third and fourth windings are connected in series or in parallel to each other.

12. The switching power supply apparatus according to claim 11, further comprising a conductor portion provided in parallel with the first or third side.

13. The switching power supply apparatus according to claim 12,
wherein the conductor portion includes at least one of a ground conductor, a metal housing, a shield, or a heat sink.

14. The switching power supply apparatus according to claim 11, further comprising a noise filter that removes normal mode noises.
